(19) United States
(12) Patent Application Publication
(10) Pub. No.: US 2019/0369403 A1
(43) Pub. Date: Dec. 5, 2019

(54) LIGHT GUIDE DEVICE AND DISPLAY DEVICE FOR REPRESENTING SCENES

(71) Applicant: SEEREAL TECHNOLOGIES S.A., Munsbach (LU)

(72) Inventor: Norbert LEISTER, Dresden Sachsen (DE)

(21) Appl. No.: 16/485,550

(22) PCT Filed: Feb. 13, 2018
(86) PCT No.: PCT/EP2018/053496

§ 371 Date: Aug. 13, 2019

(30) Foreign Application Priority Data
Feb. 13, 2017 (EP) 17155787.9
Mar. 7, 2017 (EP) 17159510.1
Jul. 13, 2017 (EP) 17181136.7

(51) Int. Cl. G02B 27/01; G02B 5/32; G02B 26/08; G03H 1/26

(52) U.S. Cl. CPC G02B 27/0172; G02B 27/0176; G02B 5/32; G02B 2027/0174; G03H 1/268; G02B 2027/0125; G02B 26/0808

(57) ABSTRACT

The invention relates to a light guiding device for guiding light. The light guiding device comprises a light guide, a light coupling device, and a light decoupling device. The light propagates within the light guide via a reflection at boundary surfaces of the light guide. The decoupling of the light out of the light guide is provided by means of the light decoupling device after a predetermined number of reflections of the light at boundary surfaces of the light guide. A display device, in particular a near-eye display device is also provided, which comprises an illumination device having at least one light source, at least one spatial light modulation device, an optical system, and a light guiding device.

The invention relates to a light guiding device for guiding light and a display device for representing scenes, in particular three-dimensional scenes, which comprises such a light guiding device. Furthermore, the invention also relates to a method for generating a reconstructed scene by a spatial light modulation device and a light guiding device.

Light guiding devices have wide applications in particular in the optical field. In particular, they are used in the field of lasers. Light guides generally have a core in the interior, which is enclosed by a cladding or a cladding layer. The light entering the light guide is usually propagated therein via total reflection. This light guiding effect because of the total reflection arises due to the higher index of refraction of the core material than the index of refraction of the cladding material or, if no cladding layer is provided, due to the higher index of refraction of the light guide material than the index of refraction of the surroundings, for example, air.

Light guiding devices or light guides can also be used in other fields, however, for example, in devices for representing reconstructed scenes, in particular in devices for representing reconstructed, preferably three-dimensional scenes or object points. Such devices can be, for example, displays or display devices located close to the eye of an observer of a scene, so-called near-to-eye displays. One near-to-eye display is, for example, a head-mounted display (HMD).

For a head-mounted display (HMD) or a similar near-to-eye display or display device, it is desirable to use a compact and light optical construction. Since such a display device is generally fastened to the head of a user, a voluminous and heavy arrangement would impair the user comfort disadvantageously.

In the case of an AR (augmented reality) HMD, it is moreover desirable for a user to be capable of perceiving his natural surroundings as much as possible without disturbances due to the HMD, on the one hand, and to be able to perceive well the content displayed on the HMD itself, on the other hand.

If a spatial light modulation device and an optical arrangement for imaging the spatial light modulation device are used, in this case the optical arrangement is to be conceived so that both light from the spatial light modulation device and also light from the natural surroundings of the observer can reach the eye.

The visibility range or field of view is also important for the user comfort in an HMD. The largest possible visibility range is advantageous in this case. In general, however, the representation of a large visibility range in combination with a high resolution requires a spatial light modulation device having a very high number of pixels.

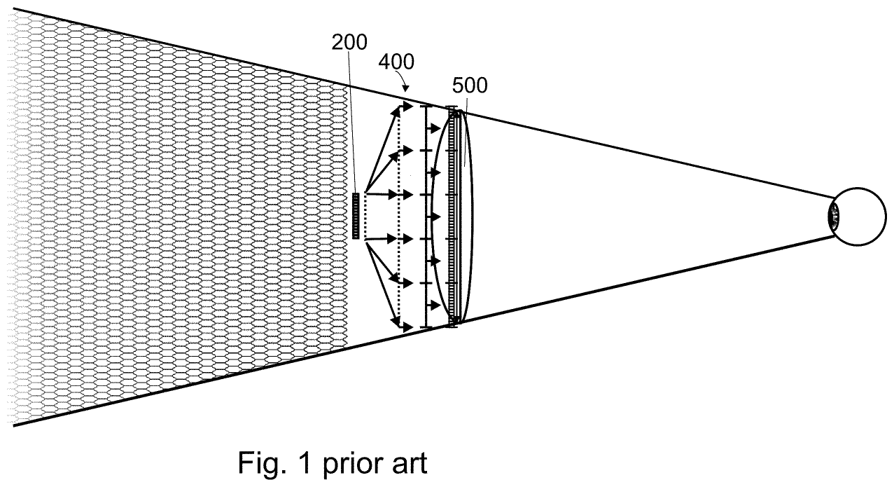

A holographic head-mounted display (HMD) having an observer window is disclosed in US 2013/0222384 A1. Such a head-mounted display is schematically shown in FIG. 1 and can achieve a large visibility range by segmenting the visibility range. In this case, various parts of the visibility range, which are visible from an observer window, are generated time-sequentially using a spatial light modulator 200 and a suitable optical system 400, 500. The advantage of this arrangement is that due to the sequential representation, a large visibility range is achieved without a high number of pixels of the spatial light modulator being required.

Various embodiments are described in US 2013/0222384 A1 to produce a multiple image of the spatial light modulator composed of segments or tiling in this way. Several described embodiments use optical components which have relatively large dimensions, however, and which only correspond to a limited extent to the requirement of a compact and/or light design or the usability in an AR-HMD.

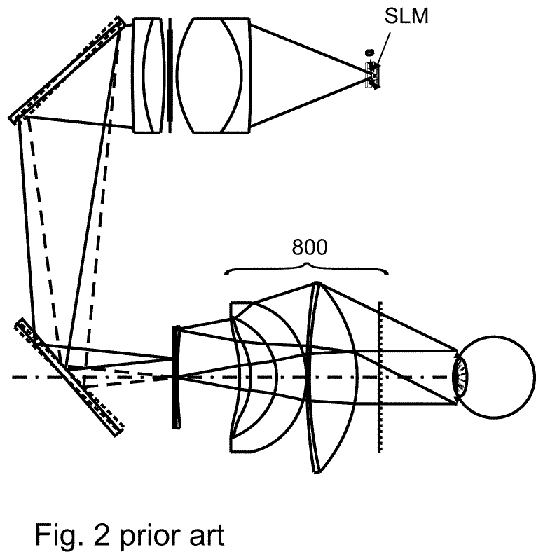

For example, an arrangement of US 2013/0222384 A1 is shown in FIG. 2, which has multiple lenses 800 closely in front of the eye of an observer. Such an arrangement is suitable, inter alia, for a VR (virtual reality) HMD. In an AR-HMD, however, these lenses 800 would have the effect that the natural surroundings, insofar as the observer can also perceive it through the lenses, would be displayed in distorted form.

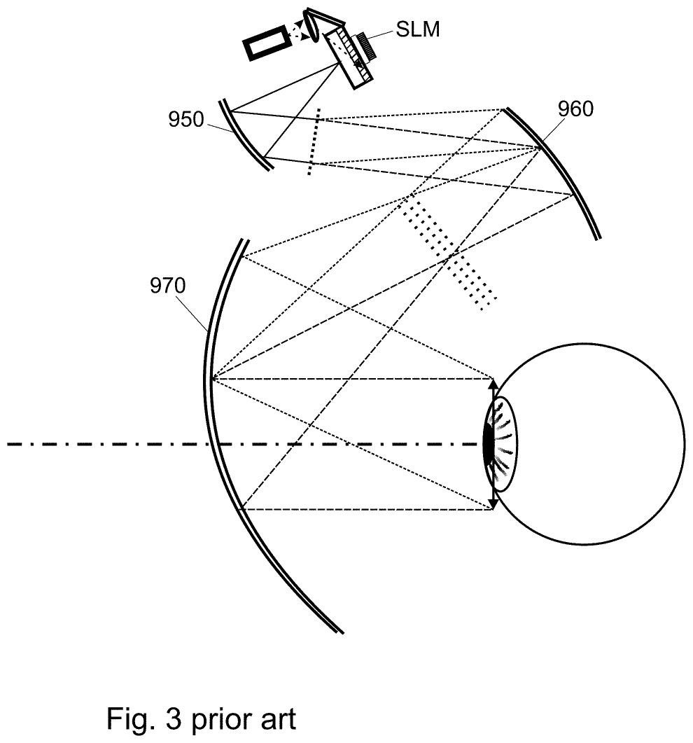

FIG. 3, which is also taken from US 2013/0222384 A1, discloses an HMD arrangement having multiple mirrors 950, 960, 970. With suitable design of the mirrors as partially-transmissive elements, this arrangement could also be suitable in principle for an observer being capable of perceiving his surroundings. This means that this arrangement could be suitable for augmented reality (AR) applications. To generate a large visibility range, however, relatively large mirrors would be required. This means it could be difficult to achieve a compact, space-saving version of this arrangement.

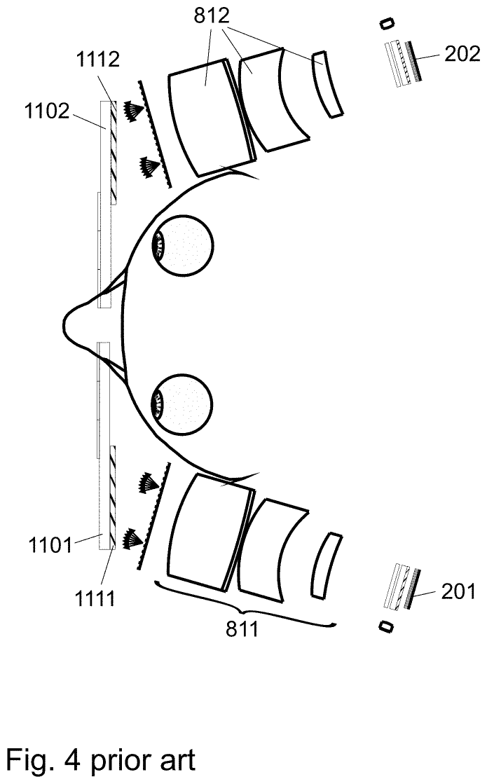

Embodiments are also described in US 2013/0222384 A1 which use waveguides. Such an embodiment is shown in FIG. 4 and has respectively one waveguide 1101 for the left observer eye and one waveguide 1102 for the right observer eye. In this arrangement, a spatial light modulator 201, 202 and an optical unit 811, 812 are each provided laterally adjacent to the head of an observer, wherein light is coupled into the thin waveguides 1101, 1102 by means of a grating 1111, 1112 respectively for each eye. The gratings, which are used as coupling optical units, are preferably designed as volume gratings, wherein light is coupled into the thin waveguides at a flat angle using them, so that the light of all coupling angles propagates via total reflection at the two boundary surfaces of the waveguide, which are arranged parallel to one another, in the direction of the waveguide. The waveguide does not have to be completely planar in this case, but rather can also have a curved surface. However, a quantitative specification about the curvature of the surface is not provided in US 2013/0222384 A1. A light deflection device generates various angle spectra, which are coupled into the waveguide time-sequentially. To generate a segmented multiple image, a different angle spectrum is coupled into the waveguide for each segment of the multiple image. The light of one of the angle spectra generated by a light deflection device is decoupled from the waveguide in the direction of the observer eye via multiple reflective volume gratings, which are each designed for a different angle range with respect to the angle selectivity thereof and are arranged adjacent to one another.

The advantage of such an arrangement according to FIG. 4 in relation to other designs described in US 2013/0222384 A1 is that the waveguide is light and compact, and the observer, if he looks through the waveguide, can also perceive his surroundings. The use of a waveguide would thus be advantageous for an AR arrangement. The use of a waveguide would not be restricted to an AR arrangement, however, but rather would also be suitable for VR arrangements. The waveguide is referred to as thin in the description in US 2013/0222384 A1, without a numeric value being specified for the thickness.

The book by Keigo Iizuka, Elements of Photonics, Volume II chapter 9 “Planar Optical Guides for Integrated Optics” is also to be cited here with respect to the light propagation in optical guides: “The foundation of integrated optics is the planar optical guide. The light is guided by a medium whose index of refraction is higher than that of surrounding layers . . . . According to geometrical optics, light will propagate by successive total internal reflections with very little loss provided that certain conditions are met. These conditions are that the layer supporting the propagation must have a higher refractive index than the surrounding media, and the light must be launched within an angle that satisfies total internal reflection at the upper and lower boundaries. This simple geometrical optics theory fails when the dimensions of the guiding medium are comparable to the wavelength of the light. In this regime, the guide supports propagation only for a discrete number of angles, called modes of propagation.” In the latter case, the light propagation is described by a wave-optical approach. The term “waveguide” is then typically used. A defined geometrical beam profile is not present in such a waveguide.

In contrast thereto, in the present application the term “light guide” is used in such a way that it refers to a sufficiently thick arrangement, for which the light propagation can be described by geometrical optics. Such a light guide can have, for example, a thickness of a few millimeters, for example, 2 mm or 3 mm.

A holographic display or display device is based, inter alia, on the effect of diffraction at the apertures of the pixels of the spatial light modulation device and the interference of coherent light, which is emitted by a light source. Nonetheless, several important conditions may be formulated and defined for a holographic display, which generates a virtual observer window, using geometrical optics.

On the one hand, the illumination beam path in the display device is significant for this purpose. It is used, inter alia, for generating a virtual observer window. A spatial light modulation device is illuminated by means of an illumination device, which comprises at least one real or virtual light source. The light coming from the different pixels of the spatial light modulation device then has to be directed in each case into the virtual observer window. For this purpose, the at least one light source of the illumination device, which illuminates the spatial light modulation device, is usually imaged in an observer plane having the virtual observer window. This imaging of the light source takes place, for example, in the center of the virtual observer window. Upon illumination of a spatial light modulation device using a planar wave, which corresponds to a light source in infinity, for example, light from different pixels of the spatial light modulation device, which exits perpendicularly from these pixels, is focused in the center of the virtual observer window. Light which does not originate perpendicularly but in each case at the same angle of diffraction from various pixels of the spatial light modulation device is then also focused at a respective identical position in the virtual observer window. In general, however, the virtual observer window can also be laterally displaced in relation to the image of the at least one light source, for example, the position of the image of the at least one light source can coincide with the left or right edge of the observer window.

On the other hand, the imaging beam path is significant in the holographic display or display device, except in a direct view display. In an HMD, in general an enlarged image of a spatial light modulation device which is small in its dimensions is generated. This is frequently a virtual image which appears to be at a greater distance to the observer than the distance at which the spatial light modulation device itself is located. The individual pixels of the spatial light modulation device are usually imaged enlarged.

However, US 2013/0222384 A1 does not contain any teaching about how the waveguide would have to be designed so that a well-defined imaging beam path and a well-defined illumination beam path are provided and both the virtual observer window and also the image of the spatial light modulator can be generated in the desired manner. In particular, as noted, it is generally not possible in a waveguide to geometrically describe a beam path. Various optical modes which propagate in a waveguide can correspond to different optical paths.

An arrangement for a non-holographic HMD having a waveguide is described, for example, in US 2009/303212 A1. A light modulator is imaged in infinity therein. Because of the infinite distance, the optical path of the light does not play a role in the propagation in the waveguide. Expressed in simplified terms, the entire path from the image of a pixel of the light modulator to the eye is then always infinitely long, even if the path component which extends through the waveguide is of different lengths.

In a holographic display, however, efforts are always being made to enable the representation of a three-dimensional (3D) scene having a large depth region. It is generally not the purpose of such a display to only represent content which is located at a very great distance from the observer. Even if the image of the light modulator is located in infinity in the holographic display, in general a three-dimensional scene would thus be represented at finite distance. With an arrangement as described in US 2009/303212 A1, under certain circumstances the light modulator itself could be correctly imaged in infinity in a holographic display. However, a correct reconstruction of an object point of a scene could not be carried out at finite distance, i.e., in front of the image of the light modulator.

A holographic direct view display which generates a virtual observer window comprises an illumination beam path. The display comprises an illumination device having at least one light source. For example, the illumination device is designed as a backlight, which generates a collimated, plane wavefront, which illuminates the spatial light modulation device. The collimated wavefront corresponds to a virtual light source which illuminates the spatial light modulation device from infinite distance. The spatial light modulation device can also be illuminated using a divergent or a convergent wavefront, however, which corresponds to a real or virtual light source at a finite distance in front of or behind the spatial light modulation device. A field lens focuses the light coming from the spatial light modulation device on the position of a virtual observer window. If a hologram is not encoded in the spatial light modulation device, an image of the light source thus results in the observer plane and the periodic repetitions of this image result as higher diffraction orders. If a suitable hologram is encoded in the spatial light modulation device, a virtual observer window results close to the zeroth diffraction order. This is referred to hereafter by stating that the virtual observer window is located in a plane of the light source image. In a holographic direct view display, the field lens which generates an image of the light source is usually located close to the spatial light modulation device. An observer sees the spatial light modulation device at its actual distance, without an image of the spatial light modulation device being present. There is then no imaging beam path.

In other holographic display devices, for example, head-mounted displays (HMD), head-up displays (HUD) or other projection displays, there can additionally be an imaging beam path, as already briefly mentioned. A real or virtual image of the spatial light modulation device is generated in these display devices, which the observer sees, where the illumination beam path is still significant for the generation of a virtual observer window. Therefore, both beam paths, illumination beam path and imaging beam path, are important here.

The case that an imaging beam path and an illumination beam path are present can also occur in other display devices, for example, stereoscopic display devices. A stereoscopic display device for generating a sweet spot can have, for example, a similar optical arrangement as that of the mentioned holographic display, i.e., a collimated illumination of a spatial light modulation device and a field lens, but also additional components, for example, a scattering element having a defined scattering angle. If the scattering element were removed from the display device, the field lens would thus generate a light source image in the plane of the sweet spot. By using the scattering element, the light is instead distributed over an expanded sweet spot, which is narrower than the inter-pupillary distance of an observer. The illumination beam path is important, however, to be able to see the stereoscopic image completely without vignetting effects. A three-dimensional stereo display device can also have an imaging beam path in this case, using which a spatial light modulation device is imaged at a specific distance from the observer.

In the general case, display devices can comprise lenses or other imaging elements which influence both beam paths, illumination beam path as well as imaging beam path. For example, a single imaging element can be arranged between the spatial light modulation device and an observer in such a way that this imaging element generates both an image of the spatial light modulation device and also an image of the light source in the observer plane.

In holographic display devices, the typical size of subholograms in the calculation of a hologram from a three-dimensional scene is dependent on the location of the three-dimensional scene in space in relation to the image plane of the spatial light modulation device. Subholograms having large dimensions arise, for example, if a scene is located far in front of the image plane of the spatial light modulation device toward the observer. However, large subholograms increase the computational effort during the hologram calculation. A method is disclosed in WO 2016/156287 A1 of the applicant, which reduces the computational effort by arithmetic introduction of a virtual plane of the spatial light modulation device. However, the option of selecting an optical system in such a way that the image plane of the spatial light modulation device results at a favorable position would alternatively also be desirable, so that the hologram can be calculated having subholograms which have small dimensions.

Due to restrictions in the optical system and/or in the imaging system, it is not possible in all cases to generate an image of the spatial light modulation device at a point favorable for the subhologram calculation. For example, the requirement of generating a large field of view in a head-mounted display could have the result that a lens having short focal length has to be used close in front of the eye of an observer. On the other hand, this can make it more difficult to generate an image plane of the spatial light modulation device in a location advantageous for the hologram calculation if it is not possible to place the spatial light modulation device close enough to the lens.

Considered generally, optical elements which are required for the illumination beam path can have disadvantageous effects on the imaging beam path and vice versa.

In an alternative design of a holographic display device, which generates a virtual observer window, imaging of a spatial light modulation device can also take place in the virtual observer window. A type of screen or also a reference plane, if a physical screen is not present, for a holographic representation of a three-dimensional scene is provided in a Fourier plane of the spatial light modulation device, thus the image plane of a light source. Therefore, in such a display device, imaging beam path and illumination beam path are also present. However, the significance thereof for the hologram plane and the observer plane is exchanged. The virtual observer window is then located in an image plane of the spatial light modulation device, therefore has reference to the imaging beam path. The hologram or the reference plane for the calculation of the hologram from the three-dimensional scene is located in a Fourier plane of the spatial light modulation device, and therefore has reference to the illumination beam path.

According to WO 2016/156287 A1, a virtual plane can be placed in the Fourier plane of the spatial light modulation device for the calculation of holograms for such a display device. Subholograms are calculated and summed in this virtual plane. The hologram which can be written into the spatial light modulation device is then determined by a Fourier transform from the summation hologram.

A display device having an image of the spatial light modulation device in an observer plane can also be used in a modified version for the purpose of generating a design of a stereoscopic three-dimensional display device having two flat views for left eye and right eye.

If a suitably calculated hologram is written into the spatial light modulation device and if the display device comprises an illumination device which generates sufficiently coherent light, a two-dimensional image is thus generated in a Fourier plane of the spatial light modulation device as the Fourier transform of the hologram. An additional scattering element can be located in this plane. If an image of the spatial light modulation device were generated in the observer plane without the scattering element, a sweet spot would thus result instead using the scattering element. The size of the sweet spot is dependent on the scattering angle of the scattering element. Such an arrangement can be used, for example, in a head-up display (HUD).

The following descriptions primarily relate to the case in which the virtual observer window or a sweet spot is present in the plane of the light source image. The statements made are also applicable accordingly to embodiments having an image of the spatial light modulation device in the virtual observer window by respective exchange of imaging beam path and illumination beam path or plane of the spatial light modulation device and Fourier plane. The present invention is therefore not to be restricted to the case having virtual observer window or sweet spot in the plane of the light source image.

A holographic display device, in which difficulties could result both with the imaging beam path and also with the illumination beam path, is the display device of US 2013/0222384 A1, as already briefly mentioned. Depending on the selected optical system, different optical paths result therein under certain circumstances in different segments of the multiple image.

For the imaging beam path, this can mean that the image plane of the spatial light modulation device is located at different depths in the individual segments. For a holographic display device, a different image plane of the spatial light modulation device in different segments can be compensated for in principle in that the subholograms are calculated for the individual segment in accordance with the respective image position of the spatial light modulation device. An object point at a specific distance from the observer could be encoded, for example, for a segment having very remote image of the spatial light modulation device as a subhologram for an object point in front of the spatial light modulation device and an object point at a similar distance in a closer image of the spatial light modulation device could be encoded as a subhologram for an object point behind the spatial light modulation device. In spite of a different distance of the image of the spatial light modulation device from the observer, a coherent three-dimensional scene can then be represented. However, it could be disadvantageous that an unfavorable image position for individual segments of the multiple image can possibly increase the size of the subholograms and thus increase the computational effort. A possible displacement of the axial position of the virtual observer window as a result of different optical paths in individual segments could be even more disadvantageous than a displacement of the image of the spatial light modulation device in individual segments. The goal of segmenting or tiling is the generation of a uniform virtual observer window, from which a large field of view is visible. A position of the virtual observer window displaced in the depth for individual segments of the multiple image would disadvantageously influence the perception of a three-dimensional scene in any case. It is therefore necessary for a uniform light source image in the same observer plane to be obtained in all segments. Moreover, an image of the spatial light modulation device at an equal or at least similar distance from an observer is additionally to be generated for all segments. Typically, as disclosed in US 2013/0222384 A1, a display device in which a light source image is generated in the observer plane would be used to generate segments of a multiple image. Segments are generated in that an image of the spatial light modulation device is generated offset in relation to one another in each of the individual segments.

A segmenting or tiling can also be generated, however, for a display device which has an image of the spatial light modulation device in the observer plane. For such a display device, the image of the spatial light modulation device is generated in every segment at the same position to generate a uniform virtual observer window for all segments. Instead, the Fourier plane of the spatial light modulation device is displaced in relation to one another in the individual segments to generate a large field of view. Since higher diffraction orders generally also result in the Fourier plane of the spatial light modulation device, such an arrangement can be generated, for example, in multiple steps, for example, by a nondisplaced Fourier plane being generated in a first step, a filtering being carried out in this Fourier plane in such a way that only at most one diffraction order is transmitted and the other diffraction orders are filtered out. In a second step, an image of this filtered diffraction order is generated, where this image is displaced in relation to one another in the individual segments to generate a large field of view. An alternative would be a single-step system having a variable filter, in which all diffraction orders are displaced in the first step, but the aperture of the filter is also displaced in such a way that in each case the same diffraction order is transmitted. The statements made on a display device having a light source image in the observer plane can again also be transferred correspondingly to a display device having an image of the spatial light modulation device in the observer plane.

Optical systems for generating an illumination beam path and an imaging beam path in a display device also have aberrations in the general case. For example, for a holographic display device having a light source image in the observer plane, the following effects can result. Aberrations of the imaging beam path influence the resolution at which an image of the spatial light modulation device is generated, and possibly in a holographic display device, also the sharpness and resolution of a three-dimensional scene, the hologram of which is encoded on the spatial light modulation device.

Aberrations of the illumination beam path influence, for example, the imaging of a sharply bounded virtual observer window. A virtual observer window which is blurry due to aberrations can result, for example, in vignetting effects, so that the entire three-dimensional scene can no longer be seen from specific positions in the virtual observer window.

If an optical element has influence on the illumination beam path as well as on the imaging beam path, its aberrations thus generally also have effects on both beam paths.

It is therefore the object of the present invention to provide a device which is usable in a display device and using which a well-defined imaging beam path and a well-defined illumination beam path can be implemented within the display device. Moreover, a display device, in particular a display device provided close to the eye of a user, having such a device is to be provided, which enables a large visibility range or field of view to be generated. This is preferably to be implementable in combination with a segmented multiple image of a spatial light modulation device. A further object of the present invention is to provide a display device which has a compact and light construction and using which a virtual observer window can be generated in each case for all segments of a multiple image of the spatial light modulation device at an identical position.

The present object is achieved according to the invention by the features of claim 1.

According to the invention, a light guiding device is proposed, which is particularly suitable for use in near-to-eye displays and in particular in head-mounted displays here, but the use is not to be restricted to these displays.

Such a light guiding device according to the invention for guiding light comprises a light guide, a light coupling device, and a light decoupling device. The light entering the light guide by the light coupling device propagates inside the light guide via a reflection at boundary surfaces of the light guide, in particular via total reflection. Decoupling of the light reflected multiple times out of the light guide is performed by the light decoupling device. The decoupling of the light is provided after a predetermined or predefined number of reflections of the light at boundary surfaces of the light guide.

This means that by means of the light guiding device according to the invention, the decoupling of the light takes place therefrom at different positions in the light guide after a respective predetermined or fixedly defined number of reflections of the light at the boundary surfaces of the light guide. In this case, an equal angle range of the light can thus also be decoupled in each case at a different position of the light guide.

It can be particularly advantageous that if the light incident on the light guiding device is formed as a light bundle or light field having multiple or a plurality of light beams, a decoupling out of the light guide is provided for the light beams after a number of reflections at the boundary surfaces of the light guide which is equal in each case for all light beams of the light bundle or light field.

A light field is to be defined according to the invention by a number of light beams within a specific region. A light field is thus the entirety of all incoming light beams.

For example, if the light guiding device were used in a display device, for example, a display device according to US 2013/0222384 A1, for a single segment of a multiple image of the spatial light modulation device, light coming from various pixels of the spatial light modulation device would be coupled into the light guide of the light guiding device and decoupled again after a number of reflections at the boundary surfaces of the light guide which is equal in each case for all pixels.

A defined geometric path is present in a light guide. Therefore, during the propagation of the light in a light guide, the optical path in the light guide and the number of reflections on its boundary surfaces can be determined in particular. In this manner, it is therefore predetermined after which previously defined number of reflections at the boundary surfaces of the light guide the light is to be decoupled therefrom.

It can therefore be provided according to the invention that a light incidence position on one of the boundary surfaces of the light guide, which the light reaches after a predetermined number of reflections, is determinable from geometric properties and optical properties of the light guide and optical properties of the light coupling device. In this case, a thickness and/or a possible curvature of the boundary surfaces of the light guide can preferably be usable as geometric properties of the light guide for determining the light incidence position, where an index of refraction of the light guide material can be usable as an optical property of the light guide. The geometry of the light guide is to be understood here as the thickness and a possible curvature of the light guide, which can be different depending on the embodiment of the light guide. The optical properties of the light coupling device relate here to at least one element provided in the light coupling device, for example, a grating element. If the light coupling element is a grating element, the optical property which influences the number of reflections of the light in the light guide is then the grating period of the grating element. To determine the desired number of reflections within the light guide, the thickness and a possibly present curvature of the light guide and the optical properties of the coupling element, in the present example the grating period of the grating element, are therefore used and taken into consideration. A required or desired number of reflections of the light in the light guide is then determined and defined from these values. The grating equation is typically known as sinβₒᵤₜ=λ/g+sinβᵢₙ, where g is the grating period, λ is the wavelength of the light, βᵢₙ is the angle of incidence of the light, and βₒᵤₜ is the emergent angle of the light. However, the equation only applies in this form if the index of refraction of the medium in the light path is equal before and after the grating element. If a coupling element is used for the coupling of light from air into the medium of a light guide, the index of refraction of the light guide n_{lightguide} is additionally to be considered: n_{lightguide} sinβₒᵤₜ=λ/g+nₐᵢᵣ sinβᵢₙ.

For example, if a light beam of the wavelength γ=532 nm is incident from air perpendicularly onto the coupling element and the coupling element has the grating period g=400 nm and the light guide material has the index of refraction n_{lightguide}=1.6, an angle βₒᵤₜ of 56.2° may thus be calculated, at which the light beam propagates after the coupling into the light guide. In a flat light guide of the thickness d=3 mm, the light beam reaches, for example, after a reflection on the opposing side of the light guide after the distance 2dtanβₒᵤₜ of, in this case, 8.96 mm, the surface of the light guide again on the side on which it was coupled in. After five reflections, the light beam could accordingly be decoupled from the light guide again at a distance of 5×8.96=44.8 mm from the coupling position.

The determined values can preferably be saved or stored in a value table (lookup table). The saving or storing of the values thus determined for the number of reflections of the light in a value table can be advantageous in that in this manner determining these values once again is not necessary and the computational effort can thus be reduced. The values can then simply be taken from the value table and used accordingly.

The light guiding device can also advantageously be used in a display device which has its utilization, for example, as an AR (augmented reality) display device, since it contributes to good perception of the natural surroundings in the AR application. In this case, an “augmented reality” is understood in general as the visual representation of items of information, which means the augmentation of (moving) images or scenes with generated additional items of information/additional representations by means of overlay and/or superposition. Of course, the use of such a light guiding device according to the invention is not to be restricted to such AR display devices.

Further advantageous embodiments and refinements of the invention may be found in the further dependent claims.

In one advantageous embodiment of the invention, it can be provided that the light decoupling device is arranged on the light guide in such a way that the position of the light decoupling device corresponds to the light incidence position which the light reaches on one of the boundary surfaces of the light guide after a predetermined number of reflections. It can be ensured in this manner that light is also decoupled from the light guide at the predetermined position of the light guide. The dimensions of the light decoupling device comprise the dimensions of a light bundle incident thereon in this case, so that it is always ensured that light is decoupled completely.

In one particular embodiment of the invention, it can be provided that the light decoupling device is designed to be controllable, where the light decoupling device is controllable in such a way that in a driving state of the light decoupling device, light is coupled out after a predetermined number of reflections and in another driving state of the light decoupling device, the light propagates further in the light guide. It is thus possible to control after how many reflections of the light in the light guide the light is to be coupled out. The number of reflections at the boundary surfaces of the light guide can thus be varied.

It can furthermore advantageously be provided that the light decoupling device is divided into sections, where the light decoupling device is sectionally designed to be controllable, where the light decoupling device is controllable in such a way that by way of one, for example, first driving state of a section of the light decoupling device, which corresponds to the light incidence position, which the light reaches after a number of reflections, and by way of another, for example, second driving state of a further section of the light decoupling device, which corresponds to the light incidence position, which the light reaches after a further number of reflections, the number of reflections of the light at the boundary surfaces of the light guide is changeable. Furthermore, the number of reflections of the light at the boundary surfaces of the light guide can be changed by further alternate controlling between various driving states of sections of the light decoupling device. The number of reflections can be varied in a particularly advantageous manner by a division of the light decoupling device into sections.

It can be particularly advantageous if the light coupling device comprises at least one grating element, preferably a volume grating, or at least one mirror element, and if the light decoupling device comprises at least one grating element, in particular a deflection grating element, preferably a volume grating, or at least one mirror element.

The coupling and decoupling of the light into or out of the light guide can be carried out in one preferred embodiment of the invention using grating elements, preferably controllable grating elements, for example, using volume gratings. If the light guiding device is used, for example, in a display device, which generates a segmented multiple image of the spatial light modulation device, for example, the decoupling of various segments out of the light guide can be controlled in such a way that at least one controllable grating element or individual sections of at least one controllable grating element of the light decoupling device is/are controlled for the decoupling, i.e., for example, is/are switched on or switched off. A switched-off grating element of the decoupling device would have the result, for example, that light which is incident on this grating element is not coupled out but rather reflected and propagates further in the light guide and after additional reflections can be coupled out at another position of the light guide.

Instead of at least one controllable grating element, at least one mirror element can also be used in the light decoupling device for coupling and decoupling of the light. For this purpose, the mirror element can have an inclined mirror surface in relation to the surface of the light guide.

A grating constant of the grating element or an angle of inclination of the mirror element in relation to the surface of the light guide can be used as an optical property of the light coupling device for determining the light incidence position, which the light reaches after a predetermined number of reflections.

It can particularly preferably be provided that the light decoupling device comprises at least one passive grating element in conjunction with a switch element, preferably a polarization-selective grating element in conjunction with a polarization switch.

Instead of at least one switchable grating element, the light decoupling device can also comprise a passive grating element in combination with a switchable element. For example, the passive grating element could be designed as a polarization-selective grating element, in particular as a polarization-selective Bragg grating element, which only deflects the light for one polarization direction of the light and does not deflect the light for another polarization direction. The polarization-selective grating element can be combined in this case with a polarization switch as a switchable element. This passive grating element in conjunction with the switch element can be provided in this case on the outer surface or cladding layer of the light guide.

In contrast to polarization gratings having large or larger grating periods, polarization-selective Bragg grating elements have grating periods of <2 μm and Bragg properties. A beam is either transmitted without diffraction or diffracted, depending on the direction of the circular polarization of the entry beam, where a maximum diffraction efficiency is only achieved at the correct angle of incidence. The production of such a polarization-selective Bragg grating element takes place in two steps. In a first step, the holographic structuring of a layer is carried out at room temperature by means of bulk photoalignment technology of a liquid crystal polymer layer, caused by photoselective cycloaddition of cinnamic acid ester groups. Finally, the thermal tempering (heating over a longer period of time) of the layer above the glass temperature Tg enhances the photo-induced optic anisotropy of the layer and thus the diffraction efficiency of the grating elements.

Circular polarization-selective Bragg grating elements having high diffraction efficiency (DE>95%), large angles of diffraction (for example, greater than 30°), and broad angle and wavelength acceptance are formed on the basis of photo-cross-linkable liquid crystal polymers (LCP). These grating elements are the result of the specific properties of these photo-cross-linkable liquid crystal polymers and a two-step photochemical/thermal processing. The holographic structuring enables a high spatial resolution and an arbitrary alignment of the liquid crystal director and also a high optical quality and thermal and chemical stability of the final grating elements.

Such grating elements can be used in combination with a polarization switch as binary-switchable deflection elements and/or as a switch element for the pre-deflection using field lenses. In addition, they can also be used as deflection polarization gratings or as reflective polarization filters. The high usable angles of diffraction combined with a high diffraction efficiency make this type of grating elements attractive for head-mounted displays in conjunction with AR (augmented reality)/VR (virtual reality) applications, because of the required system-specified short focal lengths and large numeric apertures in head-mounted displays. If two grating elements having opposing orientations are used, the angle of deflection of the light can be doubled.

A more extensive description of a polarization-selective Bragg grating element which is usable in a light decoupling device of the light guiding device is performed in the following description of the figures.

In a further embodiment of the invention, it can be provided that the at least one controllable grating element of the light decoupling device extends over a predefined area of the light guide, where the grating element is divided into switchable sections.

In one possible decoupling region of the light guide, at least one switchable decoupling element is provided in the form of a grating element. This grating element is divided into switchable sections. By switching on or switching off defined sections of the grating element, the position of the decoupling of light from the light guide can be determined and defined. This also applies to a passive grating element in conjunction with a switch element i.e., for example, to a polarization-sensitive Bragg grating element in conjunction with a polarization switch. The passive grating element would then extend over a predefined area of the light guide, where the switch element would be divided into individually switchable sections.

Decoupling elements in the form of switchable grating elements can be, for example, reflective grating elements or transmissive grating elements. Reflective grating elements can be provided on an outer side of the light guide, where transmissive grating elements can be provided on an inner side of the light guide.

In one particularly preferred embodiment of the invention, a light guide curved at least in sections in at least one direction can be provided.

In specific embodiments, it can be preferable for the light guide to have a flat or plane or planar geometry. This is the case, for example, in applications in which saving space is important, since a flat light guide occupies less installation space than a curved light guide. In other embodiments, especially for a head-mounted display, for example, the light guide can also have a curved geometry. In the general case, the light guide can also be composed of straight and curved sections or also of sections having curvature of different strengths. For example, the coupling region can be formed flat, but the decoupling region can be formed curved. In the case of a head-mounted display designed like spectacles, for example, a flat section of the light guide can be arranged laterally in relation to the head in the region of a spectacle temple and a curved section can be arranged in front of the eye of a user. A curved light guide enables the use of a grating element in the light decoupling device, the decoupling angle of which is not dependent on the position of the grating element on/in the light guide.

According to the invention, it can be provided in one advantageous embodiment of the invention that the light guide has the shape of a hollow cylinder at least in sections, where its boundary surfaces are formed as sections of the hollow cylinder having differing radius. The light guide can have, for example, a shape similar to a semicircle.

A light coupling device is provided in a coupling region of the light into the light guide of the light guiding device according to the invention. The light coupling device has at least one coupling element, for example, in the form of a grating element or a mirror element. The grating element can be designed to be controllable and/or switchable. Moreover, the coupling element can be provided on an outer or inner surface of the light guide. In one embodiment of the coupling element, it can be designed as a reflective grating element, which is provided on the inner surface of the light guide. The light incident on the light guide initially passes perpendicularly through the light guide once, is deflected on the inner surface of the light guide by the reflective grating element or mirror element, and then propagates in a zigzag through the light guide.

In one exemplary embodiment, in this case the propagation angle can be selected in such a way that by means of total reflection, a reflection occurs at the boundary surface of the light guide to the surrounding medium, for example, air. Alternatively, an additional layer, for example, a dielectric layer stack, can be provided on an inner and outer cladding surface or boundary surface of the light guide. This dielectric layer causes a reflection of the light incident at a specific or predefined angle. In this case, the dielectric layer can preferably be designed in such a way that when the light guiding device according to the invention is used in a device for an AR application, ambient light can pass through the light guide during the AR application.

It can thus furthermore advantageously be provided that the light guide has a dielectric layer on its boundary surfaces.

In one particularly advantageous embodiment of the invention, the light deflection angle of the light coupling device and the light deflection angle of the light decoupling device can be selected opposing in such a way that a light beam incident perpendicularly on the surface of the light guide also exits the light guide perpendicularly, i.e., at a right angle. In other words, the light deflection angle of a grating element of the light coupling device can be opposite to the light deflection angle of a grating element of the light decoupling device in such a way that a light beam which has entered perpendicularly through the outer surface of the light guide also exits again perpendicularly from the inner surface of the light guide.

The light guide of the light guiding device can alternately be constructed from glass or an optical plastic.

The grating element of the light coupling device and/or light decoupling device can be designed as transmissive or reflective.

The dimensions of the light coupling device can advantageously be greater than the dimensions of a light bundle incident on the light guiding device, where the coupling position of a light bundle into the light guide is displaceable within the boundaries of the dimension of the light coupling device. By displacing the coupling position of the light bundle for a predetermined or specified number of reflections in the light guide, the decoupling position of the light bundle out of the light guide is also displaceable.

The present object is furthermore achieved by a display device according to claim 18.

The display device according to the invention can be designed as a holographic display device or also as an autostereoscopic display device. The display device according to the invention can particularly advantageously be designed as a near-to eye display device, for example, a head-mounted display or also a head-up display. In this case, the display device comprises an illumination device, at least one spatial light modulation device, an optical system, and the light guiding device according to the invention.

For the explanation of the following description of the features of the display device according to the invention, it is firstly to be noted here that in the case of a large field of view, the pupils of an observer of a scene generated using the display device are typically rotated differently when the observer observes different parts of the field of view. A display device or a display having a large field of view and a virtual observer window is generally also to be understood in the meaning of this application so that the virtual observer window is co-rotated around its center point when the pupil of an eye of the observer rotates. The requirement that a virtual observer window is generated at the same position for all segments of a multiple image of the spatial light modulation device is generally to be understood so that the virtual observer window can also be tilted in relation to one another for each of various segments of a multiple image, but has a common center point.

If an observer observes various parts of a large field of view and rotates his eye at the same time, the rotation thus takes place around the center point of the lens of the eye, which is located approximately 12 mm behind the pupil. Therefore, a lateral displacement of the pupil position also automatically occurs upon rotation of the lens of the eye. A rotation by 15° corresponds, for example, to a displacement of the pupil by approximately 3.2 mm. For a display device having large field of view, which is generated, for example, using a segmented multiple image of a spatial light modulation device, an alternative embodiment can therefore also intentionally take this change of the pupil position upon rotation of the lens of the eye into consideration in such a way that the virtual observer windows of the individual segments of the multiple image are shifted in relation to one another accordingly. For segments which have an interval of 15° in the field of view, for example, the center point of the virtual observer window would then also be displaced by 3.2 mm in relation to one another, so that it corresponds to the pupil center point upon eye rotation. In this case, each segment thus intentionally has a slightly displaced position and possibly a tilted alignment of a virtual observer window in addition.

The curvature of a light guide can be adapted, for example, so that this displacement results for a perpendicular decoupling of light out of the light guide at an observer distance from the light guide surface.

In the display device according to the invention, the decoupling of light takes place at different positions in the light guiding device according to the invention after a respective predetermined number of reflections of light at the boundary surfaces of the light guide.

As already mentioned, a defined geometric path is present in a light guide. Therefore, during the propagation of the light in a light guide, the optical path in the light guide and the number of reflections at the boundary surfaces of the light guide can be defined. Therefore, the length of an employed light guide can be previously defined, the focal lengths of imaging elements of the optical system and the distances of a spatial light modulation device and a virtual observer window or sweet spot from the light guiding device can be set in such a way that a specific imaging beam path and/or illumination beam path is settable. The employed term “observer region” is to include both, a virtual observer window or a sweet spot, depending on whether the display device according to the invention is designed as a holographic or stereoscopic display device.

In one embodiment of the display device according to the invention, it can be provided that an image of the spatial light modulation device is generatable by means of the light guiding device and the optical system. The image can define a field of view within which an item of information of a scene, which is encoded in the spatial light modulation device, can be reconstructed for observation through a virtual observer region.

It can advantageously be provided that a light source image of the at least one light source of the illumination device or an image of the spatial light modulation device is generatable by means of the light guiding device and the optical system in the light path after decoupling of the light out of the light guiding device.

In this case, a virtual observer region can be generated in a plane of the light source image or in a plane of an image of the spatial light modulation device.

In a further embodiment of the invention, it can be provided that the light guide of the light guiding device is curved at least in sections as a section of a hollow cylinder, where a virtual observer region is generatable in a region of a center point of a circular arc of the hollow cylinder.

It can particularly preferably be provided in this case that a multiple image of the spatial light modulation device composed of segments is generated by the light guiding device and the optical system, where the multiple image defines a field of view, within which information of a scene encoded in the spatial light modulation device is reconstructed for observation through a virtual observer region in the plane of a light source image.

In another embodiment, it can be provided in this case that a multiple image of a diffraction order composed of segments is generated in a Fourier plane of the spatial light modulation device by the light guiding device and the optical system, where the multiple image defines a field of view, within which information of a scene encoded in the spatial light modulation device is reconstructed for observation through a virtual observer region in an image plane of the spatial light modulation device.

An image of the spatial light modulation device can be generated by means of the light guiding device and the optical system. This image defines the size of a field of view, within which a scene or an object can be generated or reconstructed.

According to the invention, to generate a large field of view, the at least one spatial light modulation device can be imaged multiple times adjacent to one another and/or also one on top of another or laterally offset in relation to one another. This is performed at such a speed that the time-sequential composition of the field of view is not perceived by the observer. However, the images can also partially or completely overlap.

The scene or the object can be generated in front of or behind or around the spatial light modulation device. In particular in a holographic reconstruction of scenes, the region of the scene generation is dependent on the depth encoding of the scene or the object in the hologram.

The spatial light modulation device can be generated so it can be imaged enlarged in the field of view. The plane of the spatial light modulation device can be enlarged in the field of view in accordance with the number of the segments to be generated in a multiple image of the spatial light modulation device, in that the images of the spatial light modulation device are generated enlarged and thus define the size of the field of view.

A detailed disclosure of the generation of a segmented multiple image of the spatial light modulation device can be found, for example, in US 2013/0222384 A1, the content of the disclosure of which is also incorporated in its entirety here.

In another embodiment, a Fourier plane of the at least one spatial light modulation device can be generated using the optical system. This can be performed, for example, using a 2f arrangement, in which the SLM is arranged in the object-side focal plane of an imaging element and the Fourier plane results in the image-side focal plane of the imaging element. A filter aperture can be arranged in this Fourier plane, which transmits at most one diffraction order and filters out other diffraction orders. A segmented multiple image of the part or parts of the diffraction order transmitted by the filter aperture can then be generated by the optical system. This multiple image of the diffraction order defines the size of a field of view, within which a scene or an object can be generated or reconstructed.

According to the invention, to generate a large field of view, the diffraction order of the at least one spatial light modulation device can be imaged multiple times adjacent to one another and/or also one on top of another or laterally offset in relation to one another. This is performed at such a speed that the time-sequential composition of the field of view is not perceived by the observer. However, the images can also partially or completely overlap.

The scene or the object can be generated in front of or behind or around the Fourier plane of the spatial light modulation device. In particular in a holographic reconstruction of scenes, the region of the scene generation is dependent on the depth encoding of the scene or the object in the hologram.

The diffraction order of the spatial light modulation device can be generated so it can be imaged enlarged in the field of view. The diffraction order in the Fourier plane of the spatial light modulation device can be enlarged in accordance with the number of the segments to be generated of the spatial light modulation device in the field of view, in which the images of the diffraction order are generated enlarged in the Fourier plane of the spatial light modulation device and thus define the size of the field of view.

The embodiment having the segmented multiple image of the at least one spatial light modulation device is described in greater detail hereafter. However, the statements are also transferable accordingly to the case of the segmented multiple image of a diffraction order in the Fourier plane of the spatial light modulation device.

The use according to the invention of a light guide in an arrangement for the segmented multiple image of the at least one spatial light modulation device means in particular that for a single segment of a multiple image of the spatial light modulation device, light from various pixels of the spatial light modulation device is coupled into the light guiding device and is decoupled again after a number of reflections of the light at the boundary surfaces of the light guide which is equal in each case for all pixels of the spatial light modulation device.

In other words, it can be provided that for the image or for a single segment of the multiple image, the decoupling of light coming from various pixels of the spatial light modulation device after entry into the light guiding device is provided after a number of reflections at boundary surfaces of the light guide which is equal in each case for all pixels.

It can furthermore be provided that for different segments of the multiple image, the number of the reflections of the light at the boundary surfaces of the light guide for the generation of one segment differs from the number of the reflections of the light at the boundary surfaces of the light guide for the generation of another segment. Different segments of a multiple image of the spatial light modulation device can be formed, for example, in such a way that for adjacent segments of a multiple image, different numbers of reflections are performed at the boundary surfaces of the light guide. However, other arrangements are also possible, which generate, for example, equal numbers of reflections of the light at the boundary surfaces of the light guide for different segments of a multiple image, but use a displaced coupling position or a changed coupling angle of the light.

As already stated with respect to the light guiding device according to the invention, decoupling of the light for the generation of various segments of the multiple image can be controlled, for example, in such a way that at least one grating element or individual sections of at least one grating element of a light coupling device are switched on or switched off to decouple light. A switched-off grating element would have the result, for example, that light which is incident on this grating element is not decoupled but rather reflected and propagates farther in the light guide and can be decoupled at another point of the light guide after additional reflections. Instead of grating elements, the light decoupling device and also the light coupling device can also comprise mirror elements, in particular mirror elements having inclined mirror surfaces. These mirror elements can also be used for coupling and decoupling of light into or out of, respectively, the light guiding device.

In one embodiment of the invention, for different segments of a multiple image, the number of the reflections of the light at the boundary surfaces of the light guide can be equal, and the coupling position of the light into the light guide can differ for these segments.

A light deflection device can advantageously be provided in front of the light guiding device in the light direction for the displacement of the coupling position of the light into the light guide. A displacement of the coupling position of the light on the light guide can preferably be carried out by a light deflection device. The light deflection device can comprise at least one grating element for this purpose, the grating period of which is settable. For example, the light deflection device can comprise two grating elements. A first grating element then deflects incident light by a settable angle, where a second grating element deflects the light deflected by the first grating element in the opposite direction by an angle having equal absolute value but opposite sign, so that essentially a parallel offset of the light results or is generated.

In a further advantageous embodiment of the display device, it can be provided that the optical system is designed as a two-step optical system, where in a first step, an intermediate image of the at least one light source of the illumination device is generated by at least one first imaging element of the optical system, where in a second step, the intermediate image of the light source is imaged by at least one second imaging element of the optical system in a virtual observer region in the light path after the decoupling of the light out of the light guide.

According to the invention, a two-step optical system can be used in the display device having a light guiding device. The display device comprises for this purpose at least one spatial light modulation device and an illumination device, which illuminates the spatial light modulation device and comprises the at least one light source. In a first step, an intermediate image of the illumination device, i.e., an intermediate image of the at least one light source which the illumination device comprises, and thus also an intermediate image of an observer region, in particular a virtual observer window or a sweet spot, is generated in the light direction after the spatial light modulation device using at least one first imaging element, for example, a lens. In a second step, this intermediate image of the illumination device is then imaged using at least one further or second imaging element, which can also be a lens, in an observer plane, more precisely in an actual virtual observer window or sweet spot. For this purpose, the light guiding device is located in the display device in the beam path after the intermediate image of the illumination beam path and the second imaging element. The at least one first imaging element simultaneously generates an image of the spatial light modulation device. The second imaging element, which images the illumination device and the virtual observer window or the sweet spot, also contributes to the imaging of the spatial light modulation device. With a suitable selection of the focal lengths of the imaging elements of the optical system, a further image of the spatial light modulation device results inside the light guiding device, in particular inside the light guide. The intermediate image of the spatial light modulation device inside the light guiding device can also only be generated in a deflection direction of the at least one grating element of the light coupling device in one embodiment of the invention, which comprises a cylindrical imaging element, while in the direction perpendicular thereto, an intermediate image of the spatial light modulation device can be located outside the light guiding device.

In addition, in one particularly advantageous embodiment of the display device, at least one variable imaging system can be provided, which is arranged in front of the light guiding device in the light direction.

This at least one variable imaging system can preferably be provided close or as close as possible to an intermediate image plane or in an intermediate image plane of the at least one light source of the illumination device and/or a variable imaging system can be provided close to the spatial light modulation device or in an image plane of the spatial light modulation device.

The at least one variable imaging system can comprise at least one imaging element, which is designed as a grating element having controllable variable period or controllable liquid crystal element or as at least two lens elements, the distances of which are variable. The at least one imaging element of the variable imaging system can be designed as transmissive or reflective. For example, the variable imaging system can comprise two controllable liquid crystal elements as imaging elements, which can both be designed as reflective. Because of the reflective embodiment of the two liquid crystal elements, a certain distance is required between the two liquid crystal elements. Therefore, the two liquid crystal elements cannot be arranged precisely in the intermediate image plane of the illumination device. The variable imaging system, if it has such liquid crystal elements, should therefore be considered overall to be arranged only as close as possible to the intermediate image plane of the illumination device.

A variable imaging system can therefore be provided in the or very close to the intermediate image plane of the illumination device, which simultaneously represents an intermediate image plane of a virtual observer window or sweet spot. A variable imaging system is to be understood here as an imaging system, the focal length of which is variable. At least one first imaging element of the optical system also generates an image of the spatial light modulation device. At least one second imaging element of the optical system, which images the virtual observer window or sweet spot, also contributes to the imaging of the spatial light modulation device. However, the image of the spatial light modulation device can advantageously be displaced in the depth using the variable imaging system in or close to the intermediate image plane of the illumination device or the virtual observer window or sweet spot, without this having effects on the illumination beam path and the position and size of the virtual observer window or sweet spot itself.

According to the invention, the image of the spatial light modulation device can therefore be displaced for each individual segment of the multiple image of the spatial light modulation device by the variable imaging system in such a way that in this case the differing optical path of the light through the light guide of the light guiding device, which results for the individual different segments, can be at least partially compensated for. The calculation of how much the image of the spatial light modulation device has to be displaced for each individual segment is performed before the display device is put into operation.

Preferably, an image visible to an observer from the virtual observer window or sweet spot of the spatial light modulation device results in this case at an equal or at least similar depth for all segments of the multiple image. The variable imaging system comprises at least one imaging element, which can be designed, for example, as a grating element having controllable variable period (for example, a liquid crystal grating (LCG)) or an electro-wetting lens or a liquid crystal lens. The variable imaging system can also comprise a system made of at least two imaging elements, for example, in the form of at least two lenses, however, the distances of which are variably settable in relation to one another, for example, a type of zoom objective lens.

A changeable prism function or a changeable lens function and/or a changeable complex phase function can advantageously be written in at least one controllable imaging element of the at least one variable imaging system.

The controllable imaging element of the variable imaging system can be arranged in an intermediate image plane of the illumination device to change the coupling position of the light into the light guide of the light guiding device. By writing in particular a changeable prism function in the controllable imaging means, the coupling position of the light on the light guide can be displaced. In this manner, the image of the spatial light modulation device can be laterally displaced in the field of view.

In such a controllable imaging element of the variable imaging system, for example, a phase-modulating element, such as a grating element having a controllable variable period (LCG), furthermore alternatively or also additionally to a changeable lens function or prism function, a changeable complex phase function, which thus deviates from a simple linear or spheric function, can also be written. For example, the phase functions for aberration correction can be polynomials. Aberrations can be described, for example, by Zernike polynomials. This procedure is advantageously used for the compensation of aberrations, in particular if the display device according to the invention is designed as a holographic display device. It can therefore advantageously be provided that the variable imaging system is arranged in a plane of the light source image of the illumination device or a Fourier plane of the spatial light modulation device for correction of aberrations in an imaging beam path.

If light is coupled and decoupled into and out of the light guide, for example, with the aid of grating elements, aberrations can thus result. These aberrations can have the effect, similarly to astigmatism, for the imaging beam path, that in the horizontal direction and vertical direction, for example, an image of the spatial light modulation device results at a different distance in relation to the observer. Moreover, different segments can also have different aberrations because of the paths of differing length between coupling element and decoupling element.

A correction of aberrations in the imaging beam path can be carried out, for example, in combination with a determination of amplitude and phase of a hologram during a backward computation from a virtual observer window through the light guide in the direction of the spatial light modulation device. However, a backward computation would then initially only take place from the virtual observer window to the intermediate image plane of the illumination device. In particular in an exemplary embodiment in which essentially aberrations of the imaging beam path are present and no or only small aberrations of an illumination beam path are present, in the backward computation, light beams in the intermediate image plane of the illumination device essentially have the correct position, but because of aberrations have the incorrect angle in comparison to target position and angle of the light beams directly in the virtual observer window. Therefore, for individual light beams, the angles can be corrected by means of a corresponding local imaging element of the variable imaging system, for example, a local deflection grating element, in the intermediate image plane of the illumination device. For example, if β (x) is the desired angle of incidence of a light beam at a position x, but β′ (x) is the actual angle of incidence of this light beam at this position x, a correction function Δβ (x)=β(x)−β′ (x) would be determined to at least partially remove the present aberration using it. The local grating period of the imaging element of the variable imaging system is then determined as g(x) =λ/tan Δβ(x), where λ is the wavelength of the light used. The grating period of the imaging element can therefore be changed or adapted in such a way that the position and the desired angle of incidence of each individual light beam then correspond to those in the virtual observer window itself, in consideration of the imaging scale from the intermediate image plane of the illumination device to the virtual observer window

The advantage of a correction of aberrations by means of a phase function in an intermediate image plane of the illumination device is that this correction is independent of the content of a preferably three-dimensional (3D) scene. The correction function can therefore be calculated once in each case for each segment of the multiple image of the spatial light modulation device and also for intermediate positions of the spatial light modulation device during a continuous displacement of the coupling position of the light in the light guide and stored in a value table and then applied again and again and corresponding grating periods can be calculated.

A second, similarly designed variable imaging system can also advantageously be arranged in an image plane of the spatial light modulation device for correcting aberrations in an illumination beam path, and for generating a virtual observer region for all segments of the multiple image at the same position.

Using the variable imaging system in an image plane of the spatial light modulation device instead of in a Fourier plane of the spatial light modulation device, aberrations in the illumination beam path can be corrected which are generated by the at least one grating element of the light coupling device and/or light decoupling device during the coupling and/or decoupling of the light into or out of, respectively, the light guide.

In a further advantageous embodiment of the display device, it can be provided that the at least one controllable grating element of the light decoupling device of the light guiding device comprises at least one lens function.

In addition to a variable imaging system, the display device in the light decoupling device of the light guiding device can also comprise, instead of a simple grating element, a grating element having at least one lens function. If multiple segments of the spatial light modulation device are generated in order to generate a large field of view, the lens function can thus differ for the individual different segments. In another embodiment, however, an identical lens function can be provided for all segments of the multiple image. For example, in a light guide in which multiple segments are only generated adjacent to one another horizontally but only a single segment is present in the vertical direction, the light decoupling device can comprise an identical cylinder lens function for all segments which generate a vertical focus. This lens functions contribute to the overall focal length of the variable imaging system. This reduces the setting range within which the focal length of the variable imaging system has to be changed.

The display device according to the invention can advantageously be designed as a head-mounted display having two display devices, where the display devices are each designed according to a display device as claimed in any one of claims 18 to 38 and are respectively assigned to a left eye of an observer and a right eye of the observer.

The present object is furthermore achieved by a method having the features of claim 40.

The method according to the invention for generating a reconstructed scene by means of a spatial light modulation device and a light guide is performed as follows:
the spatial light modulation device modulates incident light with required information of the scene,
the light modulated by the spatial light modulation device is coupled into the light guide by a light coupling device and is decoupled out of the light guide by a light decoupling device, and
the light is decoupled out of the light guide after a predetermined number of reflections at boundary surfaces of the light guide.

An image of the spatial light modulation device or a multiple image of the spatial light modulation device composed of segments is advantageously generated.

An intermediate image of the spatial light modulation device can be generated for at least a part of the segments of the multiple image within the light guide.

A first intermediate image of the spatial light modulation device is generated in front of the light guiding device or in front of the light guide in the light direction. A further intermediate image of the spatial light modulation device can be generated so that the intermediate image is located inside the light guide at least for a part of the segments of the multiple image of the spatial light modulation device. The intermediate image can also be located outside the light guide for another part of the segments of the multiple image.

Using at least one variable imaging system, preferably arranged in a plane of a light source image of at least one light source of an illumination device in the light path in front of the coupling of the light into the light guide, an image of the spatial light modulation device can be displaced for each individual segment of the multiple image in such a way that a differing optical light path in the light guide resulting for the individual segments is at least partially compensated for.

Using the variable imaging system, an aberration correction can be carried out for each individual segment of the multiple image in such a way that at least one optical property of the variable imaging system is changed, where a correction function is calculated and stored once

If the variable imaging system comprises, for example, a grating element having a controllable variable period (LCG), phase functions in the form of polynomials can thus be written therein for the aberration correction.

The aberration correction for each individual segment of the multiple image can be carried out in the intermediate image plane of the illumination device and/or in the amplitude and phase curve of a hologram encoded in the spatial light modulation device.

The calculation of the correction function can advantageously be carried out by a computational inversion of the light path and backtracing of light beams from a virtual observer region through the light guide into a plane of the light source image of the at least one light source of the illumination device.

There are various options for configuring the teaching of the present invention in an advantageous manner and/or combining the exemplary embodiments and/or configurations described above and below with one another. For this purpose, reference is to be made, on the one hand, to the patent claims depending on the independent patent claims and, on the other hand, to the following explanation of the preferred exemplary embodiments of the invention on the basis of the drawings, in which generally preferred configurations of the teaching are also explained. In this case, the invention is explained in principle on the basis of the described exemplary embodiments.

In the figures:

FIG. 1: shows a schematic illustration of a holographic display device according to the prior art;

FIG. 2: shows a schematic illustration of a further embodiment of the display device according to FIG. 1;

FIG. 3: shows a schematic illustration of a further embodiment of the display device according to FIG. 1;

FIG. 4: shows a schematic illustration of a further embodiment of the display device according to FIG. 1, where the display device is designed as a head-mounted display;

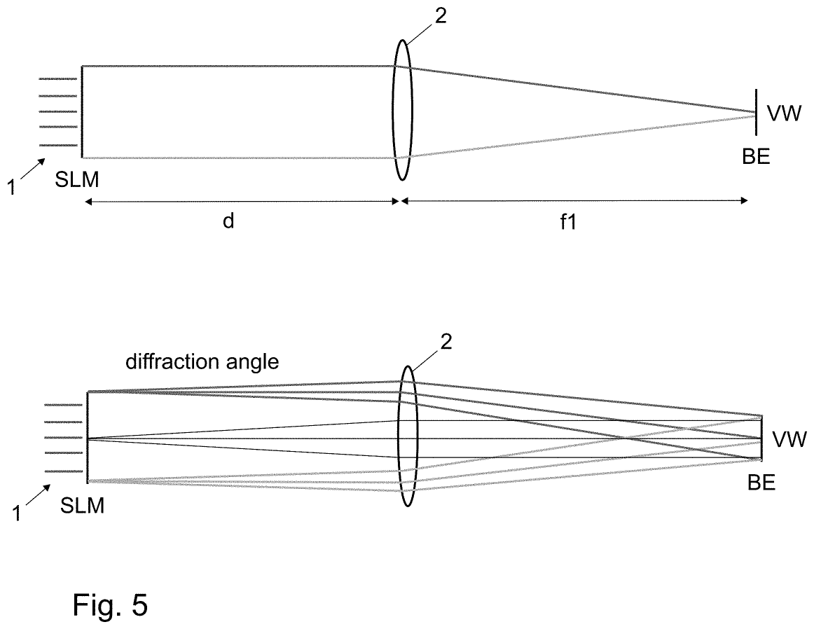

FIG. 5: shows a schematic illustration of a simple display device without provision of a light guide;

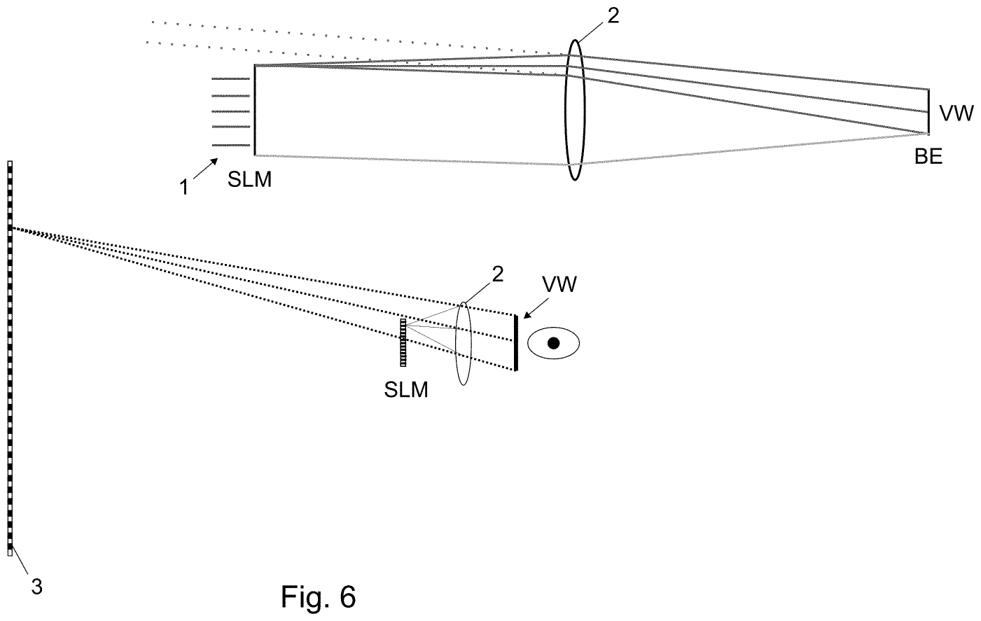

FIG. 6: shows a schematic illustration of an enlarged virtual image of a spatial light modulation device;

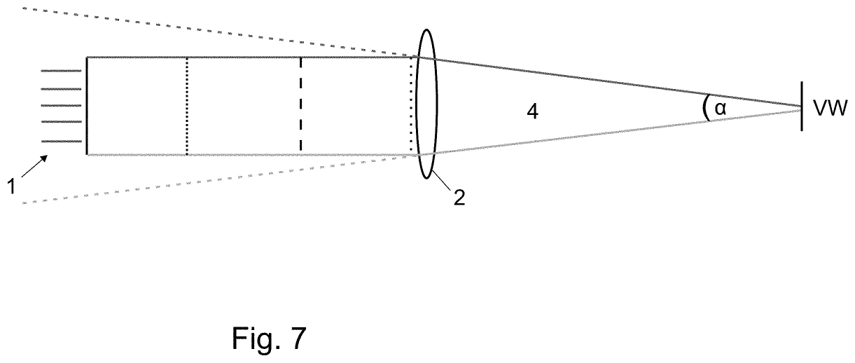

FIG. 7: shows a schematic illustration of the change of a location of a spatial light modulation device in relation to FIG. 6;

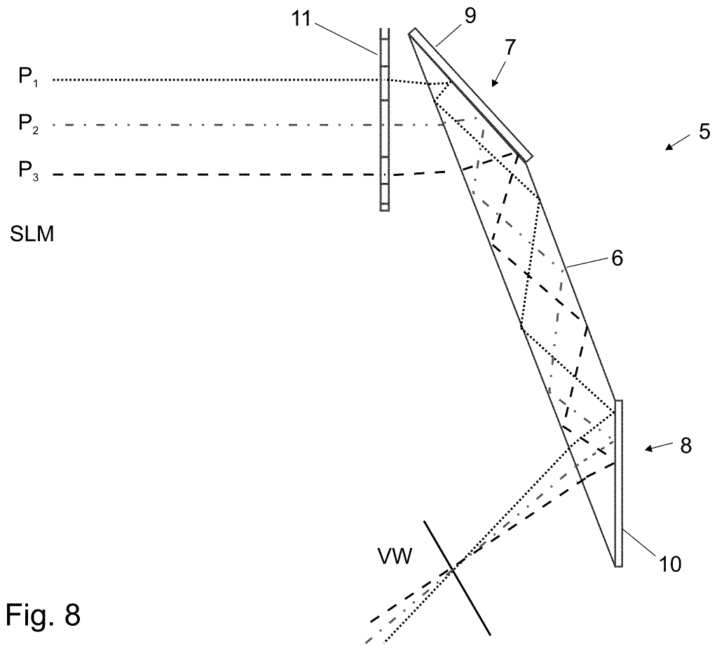

FIG. 8: shows a schematic illustration of a light guiding device according to the invention in a first embodiment;

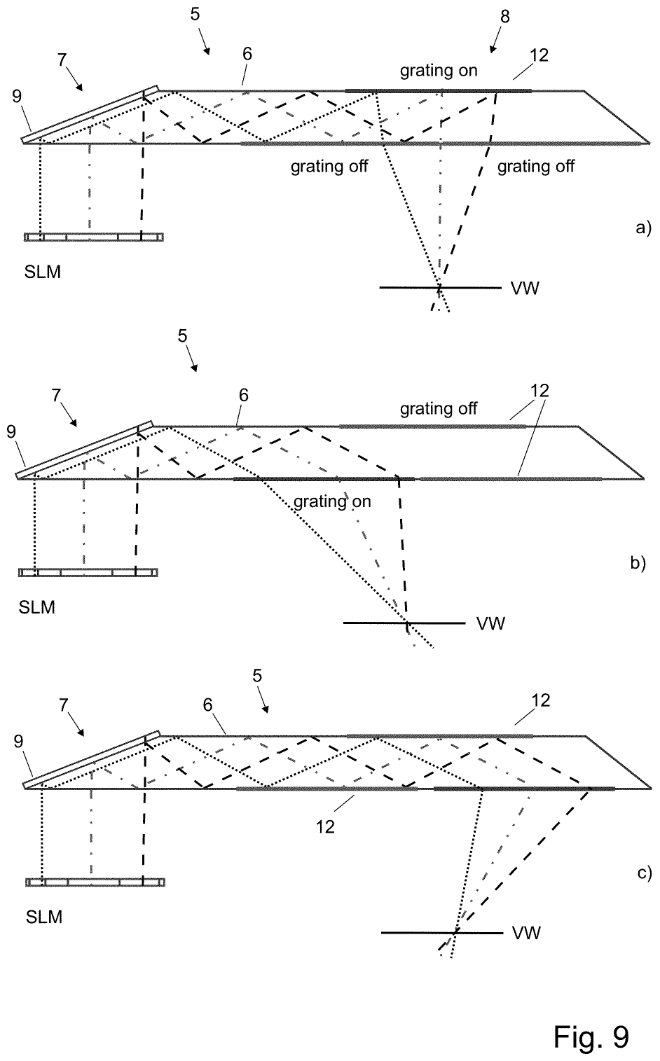

FIG. 9: shows a schematic illustration of a light guiding device according to the invention in a second embodiment;

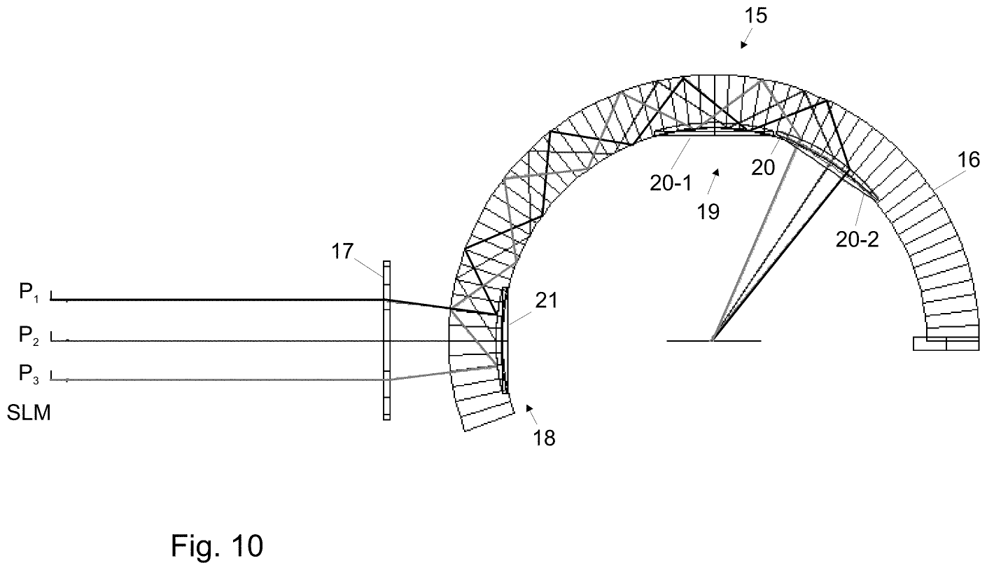

FIG. 10: shows a schematic illustration of a light guiding device according to the invention in a third embodiment;

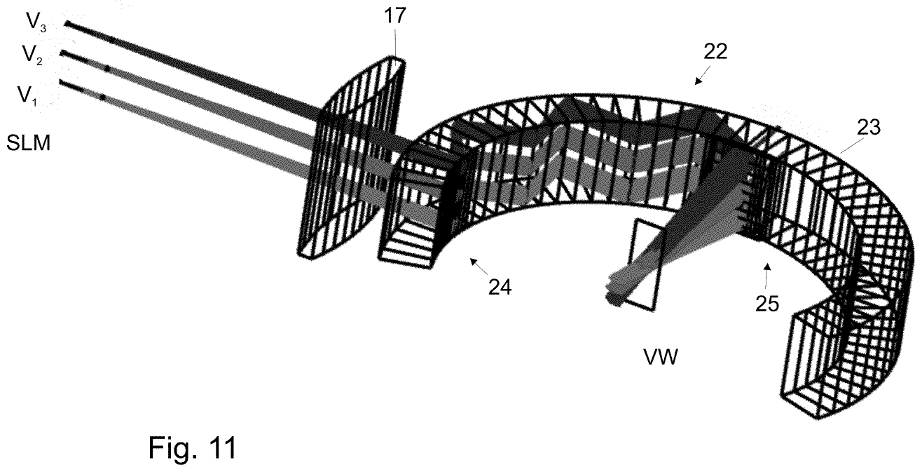

FIG. 11: shows a schematic illustration of the light guiding device according to the invention according to FIG. 10, where a light guide is cylindrically shaped;

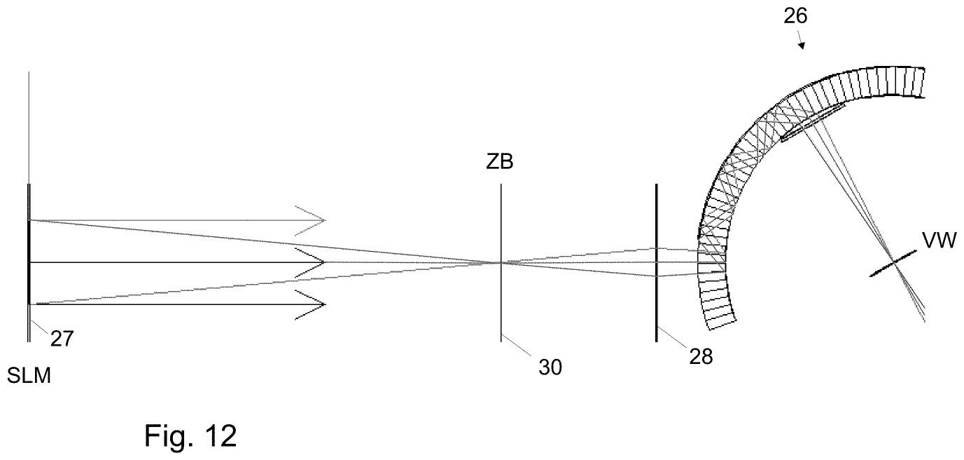

FIG. 12: schematically shows an illumination beam path for a display device having a light guiding device;

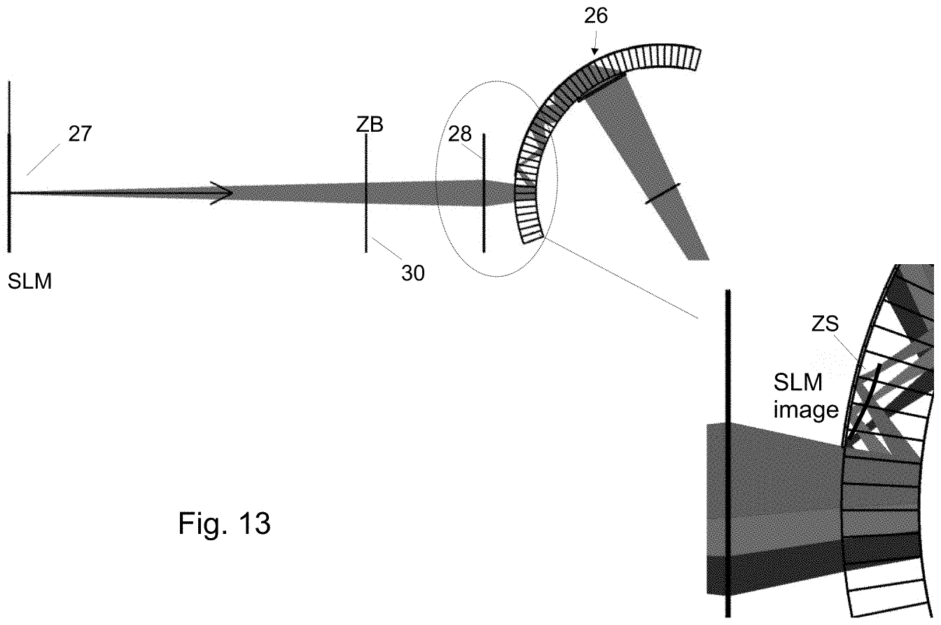

FIG. 13: schematically shows an imaging beam path for a display device, where a focus is formed inside the light guide for each of individual pixels;

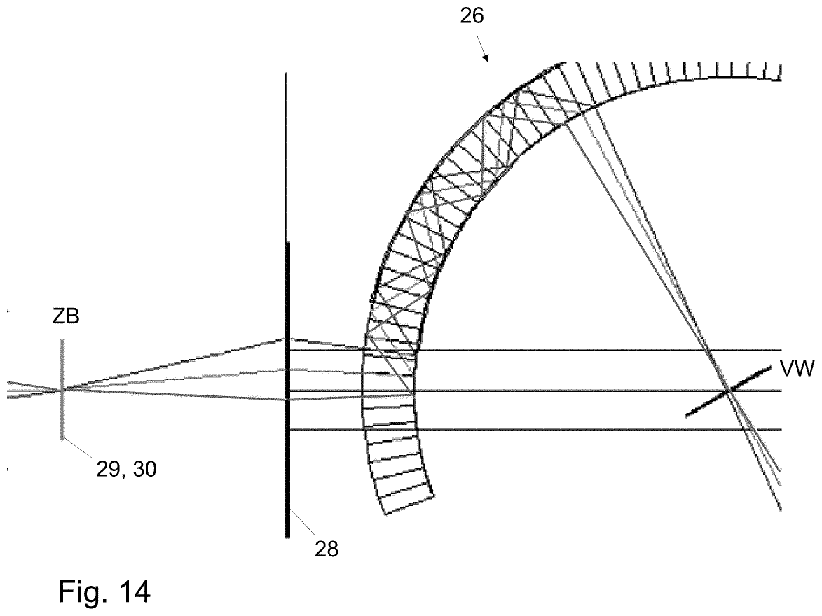

FIG. 14: schematically shows a displacement of a coupling position of the light a light deflection device;

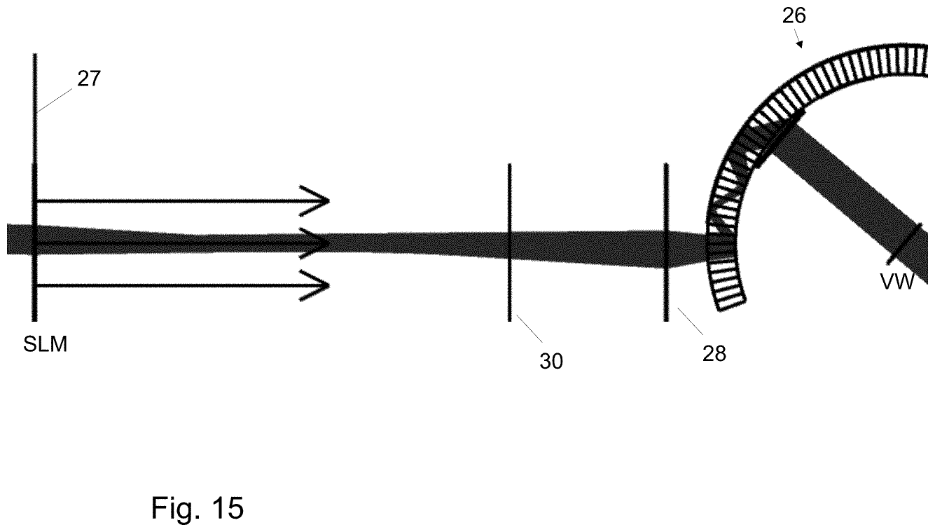

FIG. 15: schematically shows a backward computation to determine amplitude and phase of a hologram from a virtual observer window through a light guide to a spatial light modulation device;

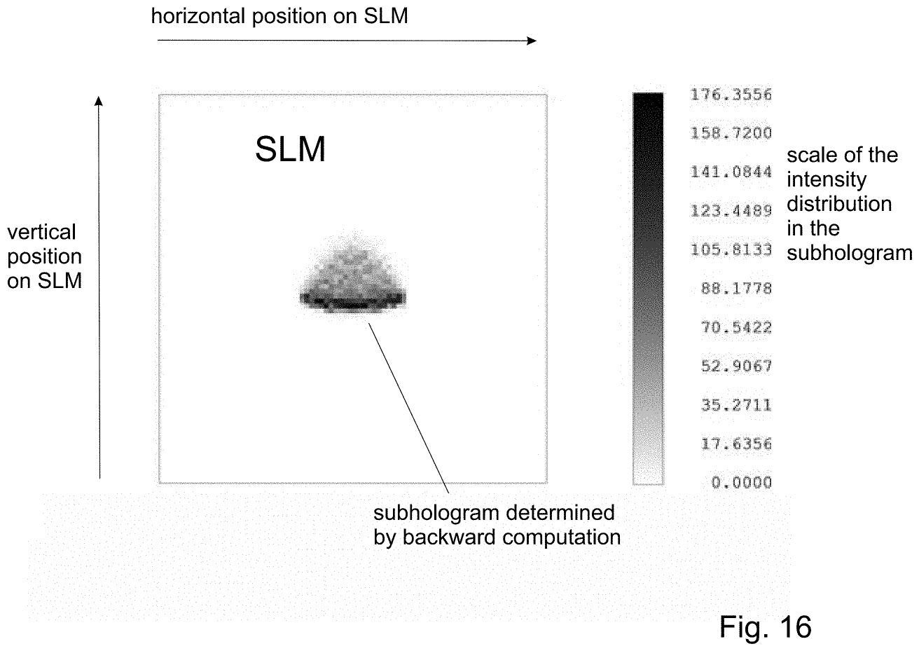

FIG. 16: shows a representation in a graph of an intensity distribution in the plane of the spatial light modulation device as would result due to a backward computation according to FIG. 15;

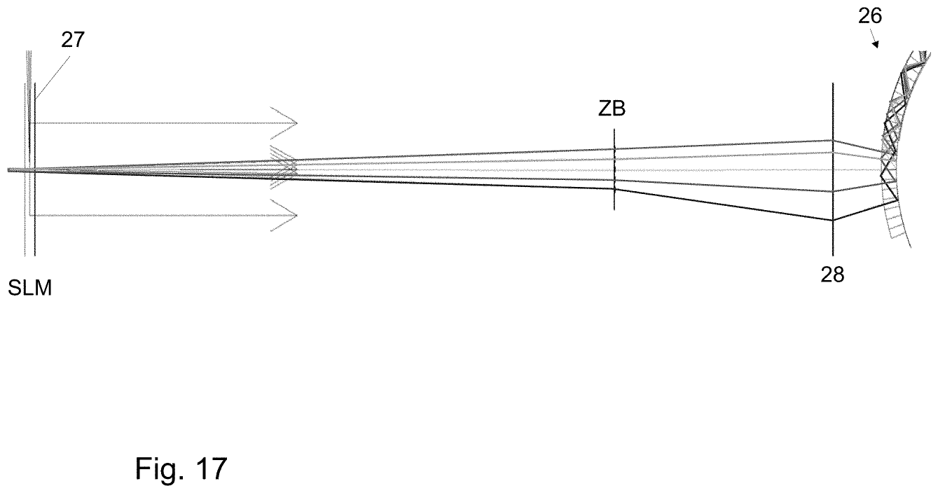

FIG. 17: schematically shows a backward computation and an aberration correction in an intermediate image plane of an illumination device;

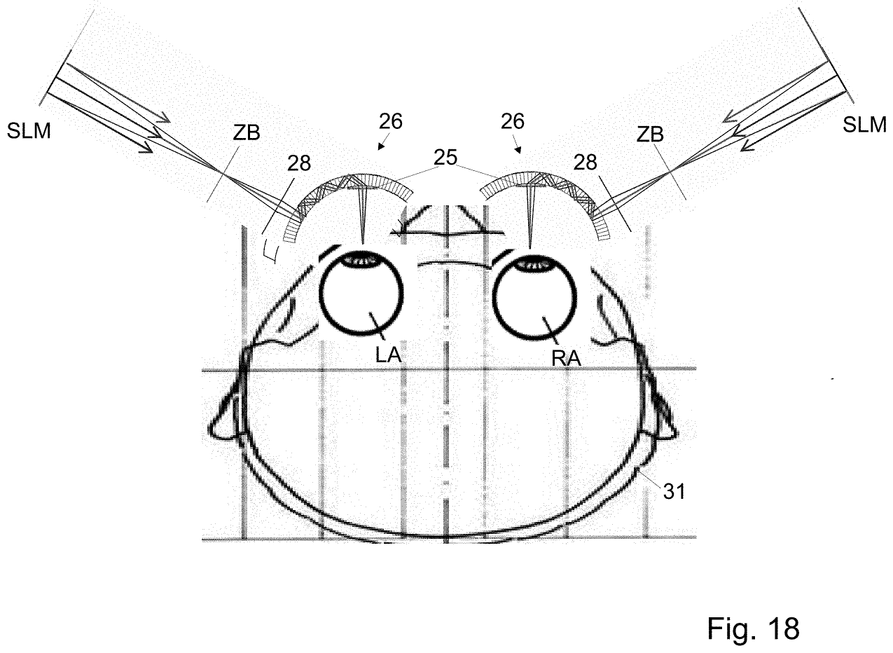

FIG. 18: schematically shows a display device according to the invention in the form of a head-mounted display;

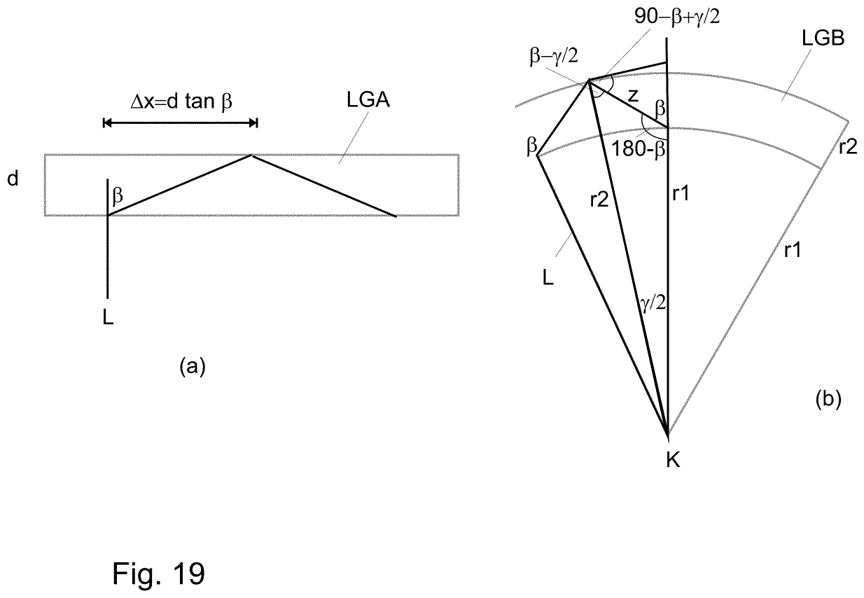

FIG. 19: shows in illustration a), a flat light guide and in illustration b), a curved light guide in conjunction with the propagation of the light in the light guide;

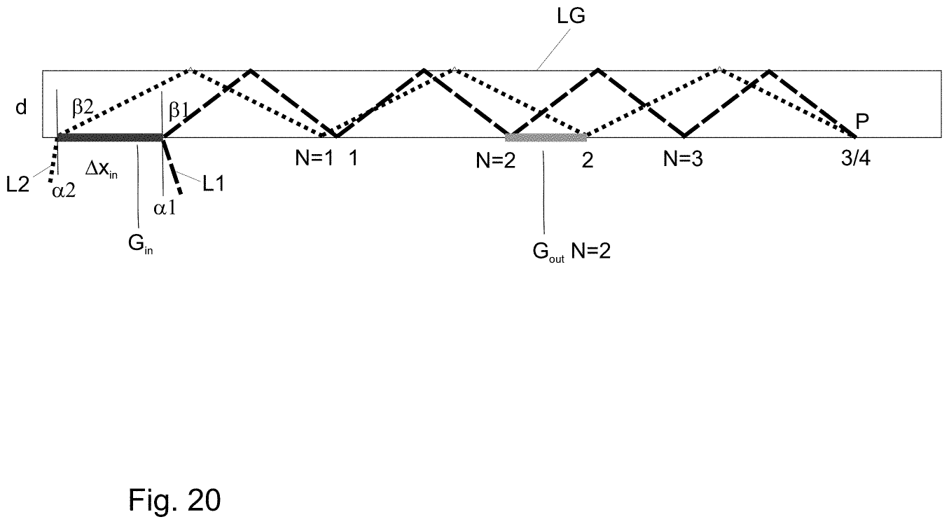

FIG. 20: schematically shows a flat light guide, where different light beams are coupled into the light guide at different positions;

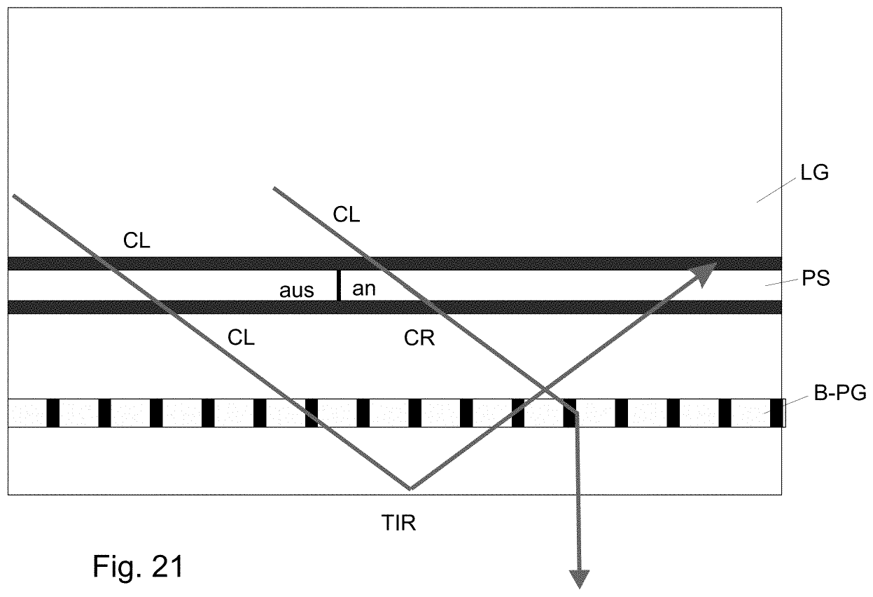

FIG. 21 schematically shows an embodiment of a light guiding device having a light guide and a light decoupling device;

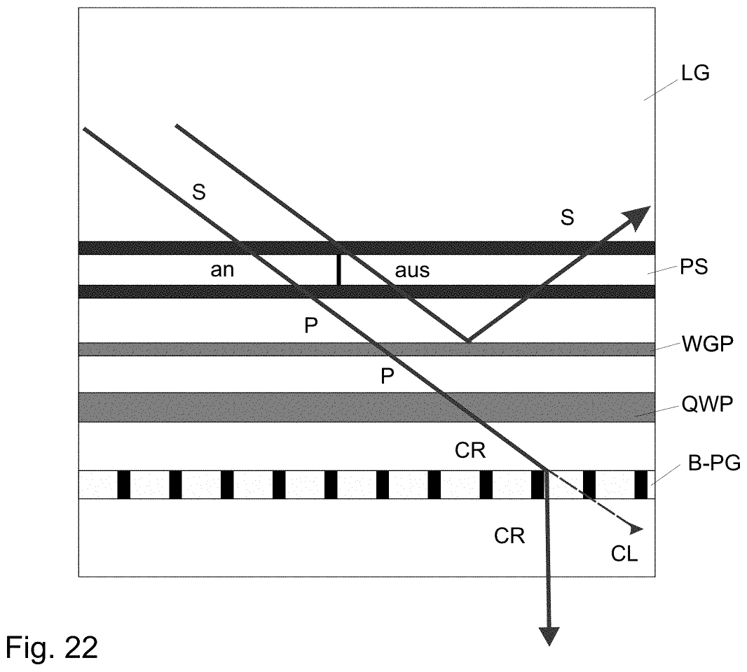

FIG. 22 schematically shows a second embodiment of a light guiding device having a light guide and a light decoupling device;

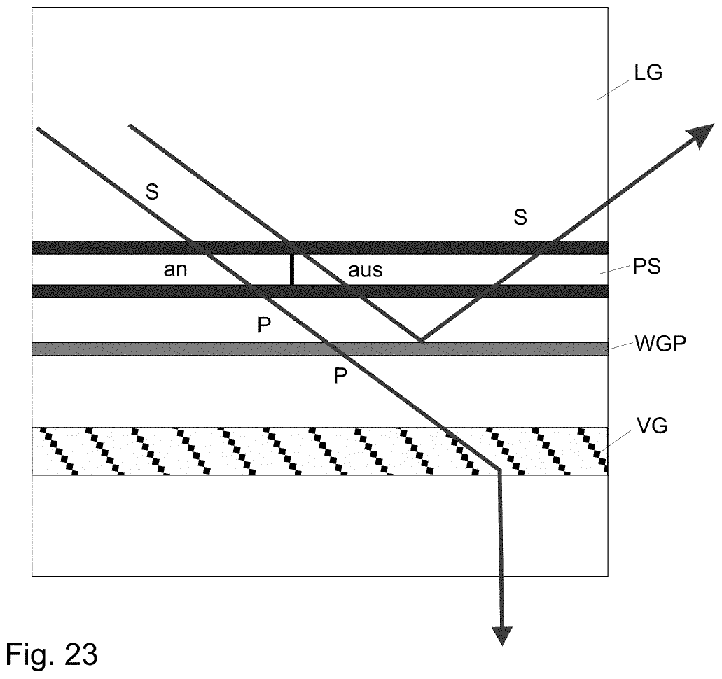

FIG. 23 schematically shows a third embodiment of a light guiding device having a light guide and a light decoupling device;

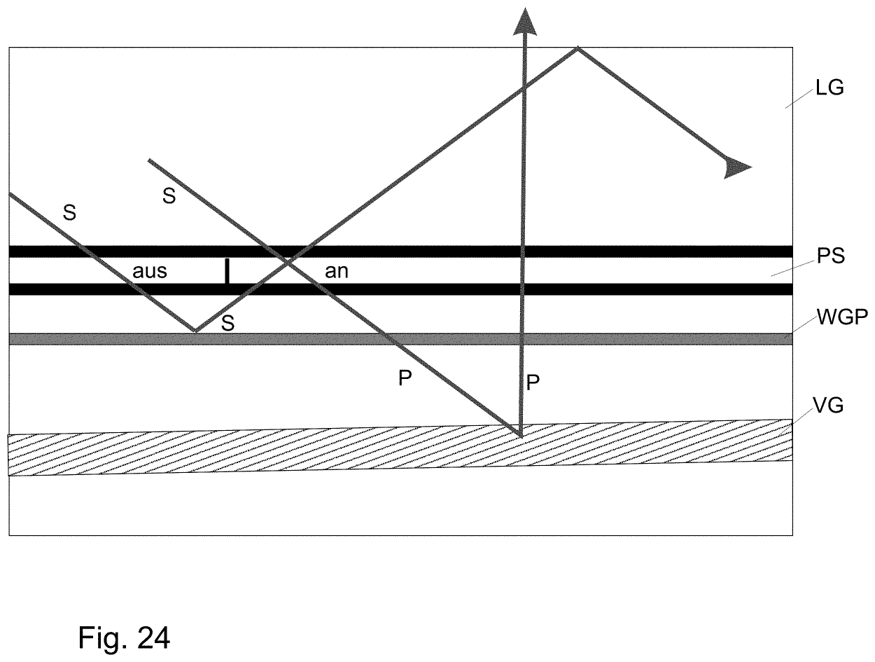

FIG. 24 schematically shows a fourth embodiment of a light guiding device having a light guide and a light decoupling device;

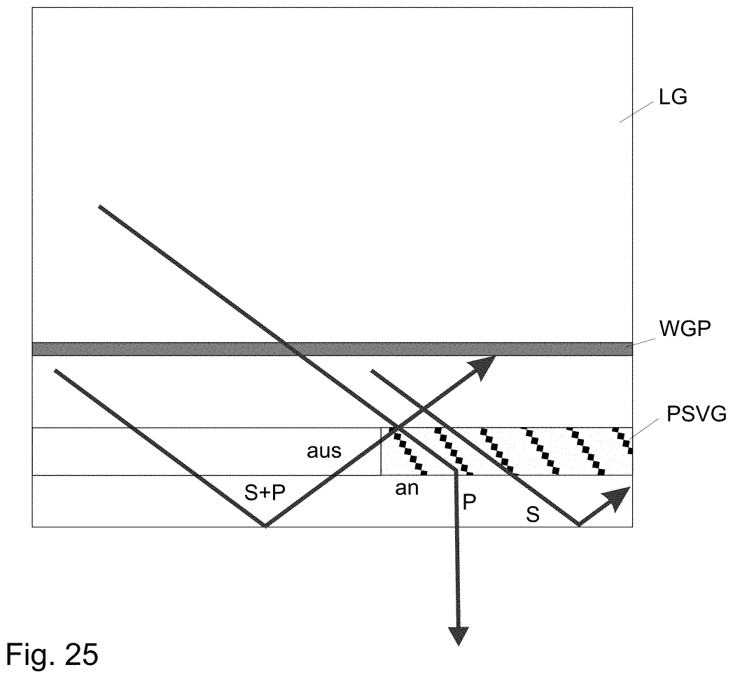

FIG. 25 schematically shows a fifth embodiment of a light guiding device having a light

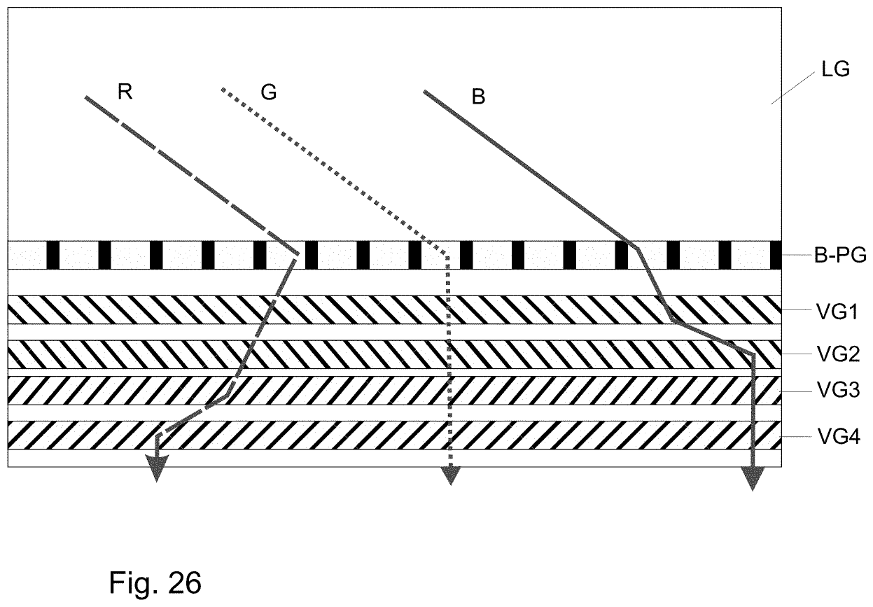

FIG. 26 schematically shows a sixth embodiment of a light guiding device having a light guide and a light decoupling device.

It is to be briefly mentioned that identical elements/parts/components also have identical reference signs in the figures.

To understand the exemplary embodiments now described, firstly the imaging beam path and the illumination beam path and the relationship of size of an observer region, i.e., a virtual observer window or a sweet spot, and the field of view in a display device, in particular on the basis of a simple holographic head-mounted display, without the use of a light guide, are to be explained. When the term “observer window” is used hereafter, this can also be understood as a “sweet spot” if the application could also apply for a stereoscopic display device. This display device comprises an illumination device, a spatial light modulation device, which is referred to hereafter as an SLM, and an optical system, which comprises idealized lenses for the explanation here, i.e., thin lenses without imaging errors. Such a display device would only have a limited field of view and would thus not be suitable for an augmented reality application, which is referred to hereafter as an AR application. Such a display device is schematically shown in FIG. 5.

An SLM is illuminated using a plane wave 1 of the wavelength λ. The plane wave 1 can be generated, for example, using an illumination device, which comprises a point light source, and is provided at a distance of the focal length from a lens of an optical system, which is located between the point light source and the SLM. A virtual image of the point light source at infinity then is produced. The SLM has a pixel pitch p and is located at a distance d from a lens 2 having the focal length f1. Upon illumination of the SLM using a plane wave, the illumination device is located at infinity. The illumination device is then imaged in the focal plane BE of the lens 2, i.e., at the distance f1 from the lens 2, which is apparent from the upper illustration of FIG. 5.

If a hologram is written into the SLM, a virtual observer window VW of the size f1 λ/p is thus produced in the focal plane BE of the lens 2. This can be taken into consideration in the geometrical optical modeling by observing light beams which originate from a pixel of the SLM at an angle of diffraction, as is apparent from the lower illustration of FIG. 5. These light beams each originating from different pixels of the SLM are shown here in different grayscale tones.

The field of view results in this case from the arctangent of the spatial dimensions of the SLM divided by the focal length f1 of the lens 2. This means that the horizontal field of view may be calculated as arctan (width of the SLM)/f1 and the vertical field of view as arctan (height of the SLM)/f1.

If the SLM has a distance d<f1 from the lens 2, according to the imaging equation 1/d′−1/d=1/f1, an enlarged virtual image 3 of the SLM is thus produced at the distance d′ from the lens having the magnification β=d′/d. This is schematically shown in FIG. 6. If the SLM had a distance d>f1 from the lens 2, a real image would thus be produced instead of a virtual image.

If the distance of the SLM from the lens 2 were now changed, but the focal length thereof were left unchanged, the virtual observer window VW, the position and the size of the virtual observer window VW, and the field of view 4 would thus remain the same, and only the position of the image of the SLM would change. This is schematically shown in FIG. 7. However, for example, if the focal length of the lens 2 were changed, the position of the image of the illumination device and the position of the virtual observer window VW and also the size of the virtual observer window VW, the size of the field of view 4 and the image position of the SLM would thus all change.

In particular, the field of view has a fixed relationship to the size of the virtual observer window, since both are dependent on the focal length f1 of the lens or the optical system of the display device. If the virtual observer window is enlarged, the field of view thus becomes smaller in its size and vice versa. In general, the lens or the optical system used influences both the illumination beam path and also the imaging beam path inside the display device.

The optical system of the display device can in general also comprise multiple lenses or imaging elements. A total focal length and a main plane of the system may then be determined according to known methods of geometrical optics. The above statements then apply accordingly to the overall system.

If a light guide is introduced into such a display device, which has an optical system having multiple imaging elements, and if initially only a single image of the SLM is used, thus a fixed coupling position and a fixed decoupling position of the light incident and propagating in the light guide, the optical path between the coupling position and the decoupling position of the light on the light guide thus has to be taken into consideration in the distances between the SLM, the imaging elements of the optical system, and the virtual observer window in the imaging beam path and illumination beam path.

If the light guide were introduced, for example, between at least one imaging element and the virtual observer window and an imaging element having a focal length of 60 mm were provided close to the coupling of the light into the light guide and the optical path through the light guide were 40 mm, a virtual observer window could thus be generated at a distance of 20 mm from the decoupling side out of the light guide.

FIG. 8 shows an illumination beam path for a display device according to the invention, which comprises a light guiding device 5. The light guiding device 5 comprises a light guide 6, a light coupling device 7, and a light decoupling device 8. In this case, the light coupling device 7 and the light decoupling device 8 each comprise at least one mirror element 9, 10. The mirror elements 9, 10 in FIG. 8 are designed as inclined mirror elements. Instead of the mirror elements, the light coupling device 7 and the light decoupling device 8 could alternately also comprise grating elements. The mirror or grating elements of the light coupling device 7 and the light decoupling device 8 will be described in greater detail hereafter. The display device comprises an SLM and an optical system having at least one imaging element. The at least one imaging element is designed here as a lens 11. The SLM and the lens 11 are located in front of the light coupling device 7 in the light direction. For the sake of simplicity, only three pixels P₁, P₂, and P₃ of the SLM are shown. The light which originates from each pixel P₁, P₂, and P₃ of the SLM is guided through the lens 11 onto the light guiding device 5 and is incident therein. The number of reflections which the light is to perform inside the light guide 6 can be determined from the geometry of the light guide 6, i.e., for example, the thickness or a possible curvature, and the optical properties of the light coupling device 7, in particular the angle of inclination of the inclined mirror element or, if a grating element is used, the grating period. Depending on where the light is to be coupled out of the light guide, a certain number of reflections of the light in the light guide 6 is necessary, which can be previously defined. These values for the number of reflections for various decoupling positions can then be stored in a value table and are thus available during use and do not have to be calculated once again. Therefore, they only have to be determined once. In FIG. 8, the light in the light guide 6 passes through a fixed number of reflections at its boundary surfaces. In this case, after the decoupling of the light out of the light guiding device 5, an image of the illumination device is produced at a defined distance therefrom. A virtual observer window VW can be generated at this point of the image of the illumination device.

If the light guiding device 5 were introduced between the SLM and the optical system, the lens 11 here, the optical path through the light guide 6 would thus influence the image position of the SLM. If the SLM is to have a distance of 50 mm from the lens 11, for example, the SLM could thus be arranged 10 mm away from the light guiding device 5, if the optical path in the light guide is 40 mm.

FIG. 8 thus shows a light guiding device 5 in a display device, in which the light of all pixels of the SLM is decoupled out of the light guiding device 5 again after a predetermined number of reflections in the light guide 6. The display device illustrated in FIG. 8 only generates a single image of the SLM.

However, to be able to generate a large field of view, a segmented multiple image of the SLM is to be generated. In such a display device, using which a large field of view can be generated, the light for individual segments of the multiple image of the SLM is decoupled out of the light guiding device at different positions.

For example, if the light is coupled into the light guiding device at a fixed position but is decoupled out of the light guiding device at different positions for different segments of the multiple image of the SLM, a different optical path through the light guide itself is thus produced for each segment, as is apparent from FIG. 9. This relates to the illumination beam path, inter alia. In particular, this would mean for a flat or planar light guide in the light guiding device, which is arranged between an imaging element having a fixed focal length and a virtual observer window, that the distance of the virtual observer window for decoupling the light out of the light guide changes for each segment of the multiple image of the SLM. However, this is disadvantageous since observation of the overall scene generated using the display device is not possible from the same position. The observer would have to move his head to see sections of the generated scene from each of various positions. It is therefore important to generate a common virtual observer window at a common position for all segments of the multiple image of the SLM at an equal distance from the light guiding device.

To remedy this disadvantage of the different positions of the virtual observer window for various segments of the multiple image of the SLM, the display device comprises a variable imaging system in the beam path. The variable imaging system comprises at least one imaging element, in particular at least one grating element having controllable variable period or a controllable liquid crystal element or at least two lens elements, the distances of which are variable. The imaging element can also be at least one lens having variable focal length. This variable imaging system is arranged in front of the light coupling device of the light guiding device in the light direction. The optical property of the variable imaging system, i.e., for example, the focal length or the grating period, is adapted for each segment of the multiple image of the SLM in such a way that in each case a virtual observer window is generated at equal distance from the decoupling side of the light guiding device.

The light decoupling device can additionally, instead of a simple grating element, comprise lens terms or lens functions, which differ for each segment of the multiple image of the SLM and contribute to the total focal length. This facilitates the setting in a setting range, within which the optical property of the variable imaging system has to be changed for the individual segments. Depending on the arrangement of the variable imaging system, however, this would generally influence both beam paths, imaging beam path and illumination beam path. To influence only the illumination beam path, the variable imaging system is to be arranged directly at the SLM or in an image plane of the SLM. For a display device having the variable imaging system which is arranged directly at the SLM between SLM and the coupling of the light into the light guide, it is generally possible by variation of the optical properties of the variable imaging system for various segments of the multiple image of the SLM to generate a common virtual observer window at the same position. As already mentioned, in particular these optical properties of the variable imaging system are related to the size of the virtual observer window and the field of view, however. Therefore, in this design according to FIG. 9, a virtual observer window is generated which is of different sizes for the individual segments of the multiple image of the SLM, and parts of the field of view which are also of different sizes for the individual segments. The individual segments of the multiple image of the SLM thus contribute to the total field of view with different weighting.

With respect to the virtual observer window, effectively only the smallest observer window size which results for each individual one of the segments of the multiple image of the SLM is also usable in this case.

In particular if lens functions are also used in grating elements of the light decoupling device for decoupling light, which differ for each segment of the multiple image of the SLM, an additional problem results:

In general, adjacent segments of the multiple image of the SLM also overlap spatially upon the decoupling of this light for the individual segments. Multiple layers of switchable grating elements would thus have to be generated one over another in the light decoupling device to generate overlapping segments of the multiple image of the SLM. In one configuration of the light guiding device, it is therefore provided that adjacent segments of the multiple image of the SLM are coupled out alternately by grating elements on a front side and a rear side or at both surfaces/boundary surfaces of a light guide of the light guiding device.

FIG. 9 shows three different illustrations of a display device having the light guiding device 5 and having an illumination beam path, in which three different segments of a multiple image of an SLM are generated. The light coupling device 7 again comprises at least one mirror element 9 here, in particular a mirror element arranged inclined. The light decoupling device 8 comprises grating elements 12 instead of mirror elements here, three grating elements in number here. The grating elements 12 are designed to be switchable or controllable. This means the grating elements 12 can be switched into an ON state and an OFF state. If the light propagating in the interior of the light guide is to be decoupled at a grating element 12, this grating element 12 is controlled and switched from an OFF state into an ON state. In this manner, the light is no longer reflected at the grating element 12 but rather decoupled by the grating element 12 out of the light guide. As is apparent from FIG. 9, a grating element 12 can be attached on an upper side or also on a lower side of the light guide. The lower side of the light guide is the side of the light guide which faces toward a virtual observer window VW. Accordingly, the upper side of the light guide is the side of the light guide which is opposite to the lower side and is farther away from the virtual observer window VW than the lower side. Grating elements 12 on the upper side of the light guide are designed as reflective grating elements and grating elements 12 on the lower side of the light guide are designed as transmissive grating elements. The SLM shown in FIG. 9 in each case in all three illustrations is to represent the SLM and the variable imaging system for the sake of simplicity. Of course, this means that the SLM and the variable imaging system are two independent components, which are not connected to one another. According to illustration a) of FIG. 9, the light originating from an illumination device (not shown) is incident on the SLM and is modulated thereby with information for a segment or also an image to be represented. The modulated light passes through the variable imaging system and is incident on the mirror element 9 of the light coupling device 7 of the light guiding device 5. The mirror element 9 reflects the light, where the light propagates in the light guide 6 by means of total reflection. The light propagating in this manner in the light guide 6 is reflected at the boundary surfaces of the light guide until it is incident on a grating element 12, which is switched into the ON state. After the illustration a) of FIG. 9, for a middle segment of a multiple image of the SLM, the decoupling of the light takes place at a switchable reflective grating element 12 on the upper side of the light guide 6. This grating element 12 on the upper side of the light guide 6 not only deflects the light accordingly, but rather additionally has a lens function. The decoupling of the light for a left segment according to illustration b) and the decoupling of the light for a right segment of a multiple image of the SLM according to illustration c) of FIG. 9 take place in each case through a transmissive switchable grating element 12 on the lower side of the light guide. These transmissive grating elements 12 on the lower side of the light guide also have a lens function.

In addition, the focal length of the variable imaging system can be varied before the coupling of the light for each segment into the light guide 6. In this manner, for all three segments of the multiple image of the SLM according to illustrations a) to c) of FIG. 9, a virtual observer window can be generated at the same position. In this example, however, for the left segment of the multiple image of the SLM according to illustration b) of FIG. 9, the virtual observer window VW is slightly smaller in its dimensions and the field of view is therefore slightly larger in comparison to the virtual observer window VW and field of view according to illustration a). For the right segment of the multiple image of the SLM, it is reversed, the virtual observer window VW is slightly larger in its dimensions and the field of view is slightly smaller. The cause of this is that the size of the virtual observer window is dependent on the optical path between SLM and virtual observer window according to λ D/p, where D is the path between SLM and virtual observer window, and this path is furthermore of different lengths in the individual segments. A smaller angle for the field of view also results at equal size of the SLM but greater distance D from the virtual observer window.

The position of the decoupling points for the individual segments of the multiple image of the SLM from the light guide is fixed by the location of the lens functions in the grating elements for decoupling, which differ for the individual segments. For example, it would not be possible to carry out a continuous displacement of the individual segments, as would be reasonable for specific applications, for example, for gaze tracking, since light would then be decoupled using two different lens functions of the grating elements.

The light guide of the light guiding device can be formed planar and/or plane or also curved.

Exemplary embodiments are set forth hereafter which each have a curved light guide. In a display device for generating at least one image of the SLM, a curved light guide instead of a planar light guide can have special advantages. On the one hand, an illumination beam path can be enabled in which it is possible without the necessity of a use of a variable imaging system, thus by means of a fixed optical system, that for multiple segments of a multiple image of the SLM, a virtual observer window can be generated in each case at the same position or location. In addition, it is possible that for multiple segments of the multiple image of the SLM, the virtual observer window can have the same size and, accompanying this, a partial field of view of equal size is also generated in each case for all segments. All segments of the multiple image of the SLM thus contribute in equal parts to the overall field of view.

On the other hand, a light decoupling device can be used, the decoupling angle of the light of which is not dependent on the position on/in the light guide or light guiding device. In particular, the decoupling angle is also equal in each case for the decoupling of various segments of the multiple image of the SLM. In particular this also enables a continuous displacement of the decoupling position of the segments out of the light guide, so that predetermined decoupling positions of the segments do not have to be provided.

In one exemplary embodiment, a curved light guide in a light guiding device forms a section of a circular arc, where a virtual observer window represents the center point of the circle.

An inner and an outer boundary surface of the light guide thus each form a circular arc, where the inner boundary surface, which is located closer to the virtual observer window, has a smaller radius and the outer boundary surface, which is located farther away from the virtual observer window, has a larger radius. The two boundary surfaces are therefore also not parallel to one another.

For example, the inner boundary surface has a radius of 30 mm and is located at 30 mm distance from the center of the virtual observer window. The outer boundary surface has, with a corresponding thickness of the light guide of 5 mm, a radius of 35 mm and is accordingly located 35 mm away from the center of the virtual observer window.

In one preferred exemplary embodiment, the light guide has a cylindrical shape, i.e., a curvature in the above-described form is present in one dimension and/or direction, and a linear extension in the dimension perpendicular thereto. For example, since typically in a display device in the form of an HMD, a large field of view in the horizontal direction is assigned greater importance than in the vertical direction, the light guide would then preferably be arranged in the display device in such a way that the curvature of the light guide extends in the horizontal direction and the non-curved or flat embodiment of the light guide extends in the vertical direction.

The light guide can also be formed curved in both dimensions and/or directions. The inner boundary surface and the outer boundary surface of the light guide then have the shape of a section of a spherical shell, where in each case the center of a virtual observer window represents the center point of the sphere.

A display device having a light guiding device, which comprises a light guide curved in at least one direction, comprises at least one SLM, an illumination device, which illuminates the SLM, having at least one light source, and an optical system having at least one imaging element. The illumination device, the SLM, and the optical system are arranged in relation to one another in such a way that in the absence of the light guiding device having the light guide, the optical system would image the illumination device in the center of a virtual observer window.

If a cylindrical light guide is used, the optical system preferably comprises a cylindrical imaging element.

The light guiding device having the light guide is then introduced into the display device so that the image of the illumination device generated by the optical system is located in the center of the circular arc of the light guide. An illumination beam path extends through this display device in such a way that light beams are incident essentially perpendicularly on the outer surface of the light guide.

With a cylindrical light guide, in the non-curved direction of the light guide, a cylindrical lens function is preferably provided in the light decoupling device of the light guiding device or a cylindrical lens is provided on or close to the decoupling side of the light guide, which focuses in this direction in the center of the virtual observer window.

If a single parallax hologram coding is provided, however, the necessity of this vertical focus can be dispensed with. Nonetheless, a lens can be provided on the decoupling side of the light guide or a lens function can be provided in the light decoupling device, which can then also have a focal length deviating from the distance to the virtual observer window, however.

A light coupling device is provided in a coupling region on the outer or inner surface of the light guide. The light coupling device can then have at least one grating element for decoupling light out of the light guide, which is a reflective grating element on the inner surface of the light guide in one embodiment. The light then initially passes perpendicularly through the light guide once, is deflected on the inner surface by the reflective grating element, and then propagates in a zigzag through the light guide.

The propagation angle of the light can be selected in such a way that a reflection occurs at the boundary surface of the light guide to air by means of total reflection. Alternatively, the propagation angle of the light can also be selected so that total reflection would not occur at its boundary surface to air. For this case, an additional layer, for example, a dielectric layer or layer stack, can be provided, which causes a reflection of the light incident at a specific angle on the layer or the layer stack, so that the light therefore propagates further in the light guide due to reflection at the layer or the layer stack. The layer or layer stack can preferably be designed so that ambient light can pass through the light guide in a possible AR application. The layer stack then selectively has a reflective effect for only a small angle range, where this angle range corresponds to the propagation angle of the light in the light guide. In this manner, the display device can also be used in an AR application.

A light decoupling device is provided in a possible light decoupling region in the light guide. The light decoupling device can comprise at least one passive or controllable or switchable grating element. By switching on or switching off the grating element or also defined sections of the grating element, if it is embodied as divided into switchable sections, the position of the decoupling of the light from the light guide can be established. If a passive grating element is used, a further switchable element is thus required, for example, a polarization-selective grating element, which only deflects light for one polarization direction and does not deflect light for another polarization direction, in combination with a polarization switch.

In the case of propagation of the light in the light guide by means of total reflection, for example, the angle is changed by the grating element of the light decoupling device in such a way that the angle falls below the total angle of reflection and the light exits from the light guide.

During the propagation of the light in the light guide, a light beam is alternately reflected at the outer boundary surface having a larger radius and the inner boundary surface having the smaller radius. By way of illustration, this contributes to a focus occurring at equal distance from the decoupling position of the light guide in each case in spite of a path of differing length of multiple light beams through the light guide after the decoupling of these light beams.

In particular, the angle of deflection of the grating element of the light decoupling device in an above-described display device is then not dependent on the position of the grating element in the light guide. For a cylindrical light guide, in which a cylindrical lens function is provided in the grating element or a cylindrical lens is used in the non-curved direction of the light guide close to the decoupling position of the light, the focal length of this lens or lens function is also not dependent on the decoupling position of the light. This can be, for example, a rectangular grating element having a cylinder lens function, which is laminated onto the inner curved surface of a cylindrical light guide, so that the focus function acts perpendicularly to the direction of curvature.

By switching the light decoupling device into an ON state or an OFF state, the light for multiple segments of a multiple image of the SLM can be coupled out of the curved light guide after a different number of reflections.

FIG. 10 shows such a curved light guiding device 15, which is provided in a display device. This display device comprises, in addition to the light guiding device 15 having a light guide 16, an SLM and an optical system. The optical system is illustrated here in the form of an imaging element 17. Light is coupled into the light guide 16 by a light coupling device 18 and decoupled again out of the light guide by a light decoupling device 19 after a predetermined number of reflections. The light coupling device 18 and also the light decoupling device 19 each comprise at least one grating element 20, 21. The at least one grating element 20 of the light decoupling device 19 is designed to be switchable or controllable and is divided here into individual sections 20-1, 20-2. The section 20-1 of the grating element 19 is in an OFF state here, where the section 20-2 is in an ON state, so that the light propagating in the light guide is coupled out at the section 20-2 of the grating element 19. If the section 20-1 of the grating element 19 were in an ON state and the section 20-2 were in an OFF state, the light would then be coupled out of the light guide after a smaller number of reflections. The light beams originating from the individual pixels P₁, P₂, and P₃ of the SLM pass through the imaging element 17 and are incident in the light guide 16. The light beams are then incident on the light coupling device 18, which is provided on an inner surface of the light guide 16. The light coupling device 18 comprises at least one grating element 21, which is designed to be reflective in this exemplary embodiment. The light beams incident on the grating element 21 are reflected and deflected in such a way that the light beams propagate via total reflection in the light guide 16. The individual light beams are then coupled out of the light guide 16 of the light guiding device 15 at the grating element 19, at the section 20-2 of the grating element here, after a predetermined number of reflections. All light beams for representing an image or a segment of a multiple image of the SLM are decoupled after an equal number of reflections.

However, instead of a different number of reflections for different segments of a multiple image of the SLM, a continuous displacement of the decoupling position of the light on/in the light guide is also possible. This can be achieved, for example, by a small displacement of the coupling position of the light with an equal number of reflections of the light at the boundary surfaces of the light guide.

A large field of view can then be generated, for example, by using a different number of reflections at the boundary surfaces of the light guide for generating individual segments of a multiple image of the SLM for larger steps and a continuous displacement of the coupling position of the light for the individual segments of the multiple image of the SLM in between for smaller steps. For example, a field of view 60° in size could be generated from six segments of 10° each, which do not overlap. In this case, the light guide and the grating element of the light coupling device could be designed so that by way of an additional reflection in the light guide, the decoupling position of the light is displaced by 20° from the viewpoint of the observer. In addition, by way of a displacement of the coupling position, the decoupling position could be displaceable for a fixed number of reflections by 10° from the viewpoint of the observer.

For example, a first segment would then be generated by the light being decoupled after one reflection for a nondisplaced coupling position. A second segment would be generated by the light being decoupled after one reflection for a coupling position displaced by 10°. A third segment would be generated by the light being decoupled after two reflections for a nondisplaced coupling position. A fourth segment would be generated by decoupling the light after two reflections for a coupling position displaced by 10°. A fifth segment would be generated by the light being decoupled after three reflections for a nondisplaced coupling position. A sixth segment would be generated by the light being decoupled after three reflections for a coupling position displaced by 10°.

Alternately, a small change of the angle of deflection of the light generated by the grating element 20 of the light coupling device 18 could also be used to generate a large field of view. However, it is also necessary for this purpose for the grating element 20 to be designed as controllable or switchable.

A displacement of the coupling position of the light on the light guide is preferably performed by a light deflection device 29, which can comprise at least one grating element. This will be described in greater detail in conjunction with FIG. 14. The grating element has a grating period which is settable. For example, a pair of two grating elements can be used in the light deflection device, the first grating element of which deflects light from the SLM and the second grating element of which then deflects light in the opposite direction, so that essentially a parallel offset results.

In a display device which has a two-step optical system or a two-step imaging of the light, i.e., generates an intermediate image of the illumination device, the light deflection device can be arranged in an intermediate image plane of the illumination device. As an example, a field of view of approximately 60° can be achieved in the direction of the curvature of the light guide by rough steps of 20° being achieved after one additional reflection in each case on front and rear sides and in addition the coupling position being shifted by up to ±10° by the light deflection device.

With a cylindrical light guide, a displacement of the coupling position of the light on the light guide in the non-curved direction can also be carried out by a light deflection device. For example, a vertical field of view 20° in size can be composed of two segments of 10° each, where light is coupled in either on the lower or the upper half of the light guide by displacing the vertical coupling position.

FIG. 11 shows, in a perspective view, a display device comprising an SLM, an optical system, again in the form of the imaging element 17 here, and a light guiding device 22, which comprises a cylindrical light guide 23. As can be seen, in the non-curved direction of the light guide 23, light from different vertical positions V₁, V₂, V₃ of the SLM is coupled into the light guide 23 by a light coupling device 24. The light propagating thereafter in the light guide via total reflection is decoupled by a light decoupling device 25 and is focused at the decoupling side of the light guide 23 by a vertical cylindrical lens function, which is integrated into the light decoupling device 25, in a virtual observer window VW.

A continuous displacement of segments is also reasonable, inter alia, if different sections of the field of view are to be represented depending on the content of a preferably three-dimensional (3D) scene to be represented or depending on precisely where the eye of an observer looks during the observation of the scene.

Thus, for example, it can be detected in an HMD precisely which parts of the scene an observer is looking at and only these can be holographically represented, for example.

A display device having a two-step optical system or two-step imaging will be described in greater detail hereafter.

In a holographic display device, for example, an HMD, in general an SLM is imaged. In the case of a segmented multiple image, one image of the SLM results in each case in each segment. An image of the SLM at a predefined distance presumes specific focal lengths of the used imaging elements of the optical system and a specific distance of the SLM from these imaging elements.

In particular, imaging beam path and illumination beam path in the display device are in general not independent of one another. Possibly required settings of the illumination beam path can possibly also result in changes of the imaging beam path.

In a configuration of the display device using a flat and/or plane light guide and at least one imaging element, for example, a lens, before the coupling into the light guide in the light direction, for example, as described above, the necessity results of varying the focal length of this at least one imaging element to set the same position of a virtual observer window for various segments of a multiple image of the SLM. If the distance of the SLM from the imaging element is fixed, the position of the imaging of the SLM thus changes if the focal length of the imaging element is varied. Therefore, in a segmented multiple image of the SLM, a different image plane of the SLM would result for each segment.

In another configuration of the display device using a light guide, which comprises at least one lens exclusively between the light decoupling device of the light guiding device and an eye of an observer or a lens function which is integrated into the grating element of the light decoupling device, the focal length of the at least one lens between the decoupling of the light and the observer does have to be equal for all segments of the multiple image of the SLM. However, because of the optical path of different lengths of the light of the individual segments of the multiple image of the SLM through the light guide, the distance between the SLM and the at least one lens or lens function in the grating element of the light decoupling device is then of different lengths for each segment. Therefore, the image of the SLM is also generally at a different distance or at a different position for each segment of the multiple image of the SLM in this case.

In a holographic display device, it is not absolutely necessary to have a common image plane for all segments of the multiple image. A 3D scene can also be represented continuously over segment boundaries having different image planes of the SLM, for example, by the focal lengths of subholograms of a hologram on the SLM being adapted in the individual segments. An object point of a scene can be represented, for example, in a segment of a multiple image of the SLM by a subhologram having a positive focal length (convex lens) if the object point is located in front of the image plane of the SLM for this segment. An adjacent object point in another segment but at the same depth in relation to the observer can be represented, for example, by a subhologram having a negative focal length (concave lens) if the object point is located behind the image of the SLM for this segment. On the other hand, however, it simplifies the hologram calculation if the image plane of the SLM is at least similar for all segments, i.e., it only differs by a few centimeters but not by multiple meters, for example.

If grating elements are used in the coupling and/or decoupling of light into or out of, respectively, a light guide, in particular grating elements having a small period, for example, in the range of 1 μm or less, and therefore a large angle of deflection of typically more than 30°, for example, between 50 and 60°, in general aberrations thus result in the optical beam path.

To keep the aberrations as small as possible, it is preferable to use a pair of grating elements for the coupling and decoupling of the light into and out of a light guide. This means one grating element is provided in the light coupling device and one grating element is provided in the light decoupling device, where the two grating elements have essentially opposing equal angles of deflection. In a first grating element, i.e., the grating element of the light coupling device, for example, perpendicularly incident light is deflected by an angle of 60° in relation to the normal.

In a second grating element, i.e., the grating element of the light decoupling device, light which is incident at 60° is deflected in such a way that it exits perpendicularly from the grating element. After passing through both grating elements, the exit angle of the light out of the second grating element thus corresponds to the entrance angle of the light into the first grating element. This arrangement of two grating elements in a light guiding device for coupling and decoupling light into or out of, respectively, a light guide is advantageous to keep small or reduce aberrations of an illumination beam path in the display device, for example, in an HMD. The remaining aberrations affect the imaging beam path in particular. Because of these aberrations, the position of the image of the SLM can be displaced unfavorably far in comparison to a light guiding device without the use of grating elements in the light coupling device and/or light decoupling device. In particular, this displacement of the image of the SLM primarily takes place in the direction in which the grating elements deflect the light, so that an astigmatism of the SLM image can also result. For grating elements which deflect horizontally, for example, the horizontal pixel image of the SLM would result at a different depth than the vertical pixel image of the SLM.

To compensate for or reduce the influence of grating elements in the light guiding device on a position of the image of the SLM, an intermediate image of the SLM can be generated inside the light guide and/or the light guiding device.

The display device can use a two-step optical system to generate an intermediate image of the SLM. In this case, in addition to this two-step optical system, the display device comprises at least one SLM and one illumination device having at least one light source which illuminates the SLM. In a first step, an intermediate image of the illumination device and thus also an intermediate image of a virtual observer window to be generated is generated in the light direction after the SLM using at least one first imaging element, for example, a lens, of the two-step optical system. In a second step, the intermediate image of the virtual observer window and also the intermediate image of the illumination device is imaged using at least one second imaging element, for example, a lens, of the two-step optical system in the actual virtual observer window or in an observer plane. In this case, the light guiding device is located in the display device in the beam path after the intermediate image of the virtual observer window and the second imaging element. The arrangement having the first and the second imaging element also generates an image of the SLM. The second imaging element, which images the intermediate image of the virtual observer window or the intermediate image of the illumination device, respectively, can also contribute to the imaging of the SLM. With suitable selection of the focal lengths of the imaging elements, a further image of the SLM is produced inside the light guide of the light guiding device. This intermediate image of the SLM inside the light guide can also only be generated in the deflection direction of the grating elements of the light coupling device and/or light decoupling device using a cylindrical imaging element, for example, while an intermediate image of the SLM can be located outside the light guide in the direction perpendicular thereto.

A display device having a two-step optical system is illustrated in FIG. 12. The display device additionally comprises at least one SLM and a light guiding device 26. The light guiding device 26 is arranged in this case in the light direction after the two-step optical system, which comprises at least two imaging elements 27 and 28. A first imaging element 27 is arranged in the light direction after the SLM, but in the immediate vicinity of the SLM. FIG. 12 schematically shows the illumination beam path for such a display device in this case, where the imaging element 27 generates an intermediate image ZB of an illumination device (not shown). The intermediate image ZB of the illumination device is then imaged by means of the imaging element 28 in a virtual observer window VW, where an image of the illumination device again is produced. An imaging system 30 can be provided in the plane of the intermediate image ZB, which has no effect on the illumination beam path, however. Its function for the imaging beam path will be explained hereafter.

FIG. 13 shows an imaging beam path for the display device according to FIG. 12, where an overview illustration of the imaging beam path is shown in the upper illustration and a detail view of the circled region in the upper illustration is shown in the lower illustration. Light is illustrated originating from only one pixel of the SLM in the upper illustration for the sake of clarity. As can be seen, after passing through the imaging elements 27 and 28 and the imaging system 30, the light enters the light guide of the light guiding device, propagates via total reflection in the light guide, and is then decoupled again by the light decoupling device.

The circled region of the upper illustration is illustrated in greater detail in the lower illustration, where not only one light beam, but rather multiple light beams which originate from multiple pixels of the SLM, are shown, however. It can be seen from this detail view that one focus inside the light guide results in each case for the individual pixels of the SLM by means of the imaging elements 27 and 28 and the imaging system 30. This means that a further image ZS of the SLM is produced inside the light guide of the light guiding device 26. The imaging system 30 in the plane of the intermediate image ZB of the illumination device has the advantageous property that it only influences the imaging beam path but not the illumination beam path. If the imaging system 30 is, for example, a lens element, the image plane of the SLM can thus be displaced by suitable selection of the focal length of this lens element, without the position of the virtual observer window being displaced inadvertently.

In the present example, the imaging element 28 is also a lens element. Firstly, the focal length of this lens element is selected so that after the light is coupled out of the light guide 26, a virtual observer window is generated. In consideration of the focal length of the imaging element 28, the focal length of the lens element of the imaging system 30 is then selected so that an image ZS of the SLM is generated inside the light guide of the light guiding device 26.

The size of the aberrations in the imaging beam path, which result due to the grating elements for coupling and decoupling the light, is also dependent on the distance of the grating elements, i.e., on the distance of the at least one grating element of the light coupling device from the at least one grating element of the light decoupling device. Therefore, various segments of a multiple image of the SLM in a light guide, in which the light propagates a different distance in the light guide, and therefore have a different distance between the grating element for coupling the light and the grating element for decoupling the light, would also result in different aberrations in the imaging beam path for each segment.

As a solution for a differing depth position of the individual segments of the multiple image of the SLM from the viewpoint of the virtual observer window because of different distances of the individual segments of the multiple image of the SLM from the imaging elements of the optical system because of paths of different lengths of the light in the light guide or also due to aberrations, which are generated by grating elements for coupling and decoupling, the following is proposed: As already disclosed, in addition to the two-step optical system, the display device comprises at least one SLM and an illumination device which illuminates the SLM. In a first step, an intermediate image of the illumination device and thus also an intermediate image of a virtual observer window is generated in the light direction after the SLM by at least one first imaging element. In a second step, the intermediate image of the illumination device and thus the intermediate image of the virtual observer window are imaged by at least one second imaging element in the actual virtual observer window. In addition, this display device comprises a variable imaging system, see FIG. 15, for example. This means the imaging system 30 in the intermediate image plane ZB is designed to be variable in this case. The variable imaging system 30 is arranged in the intermediate image plane ZB of the virtual observer window or close to this intermediate image plane. The variable imaging system 30 comprises at least one imaging element, which can be designed to be controllable. For example, the focal length of the imaging element can be variable. The arrangement having the first and the second imaging element 27, 28 also generates an image of the SLM. The second imaging element 28, which images the virtual observer window, also contributes to the imaging of the SLM. However, by using the imaging element of the variable imaging system in the or as close as possible to the intermediate image plane of the virtual observer window, the image of the SLM can advantageously also be displaced, without this having effects on the illumination beam path and the position and size of the virtual observer window itself. The image of the SLM is displaced for each segment of a multiple image of the SLM by the imaging element of the variable imaging system in such a way that the differing optical path of the light through the light guide, which results for the individual segments, is at least partially compensated for.

Due to the compensation, a visible image of the SLM observable for the observer through the virtual observer window results for all segments in an equal or at least similar depth. The imaging element of the variable imaging system 30 can be, for example, a grating element having controllable variable period (LCG—liquid crystal grating), an electrowetting lens, a liquid crystal lens, or also a system made of at least two imaging elements such as lenses, the distances of which are changed, similar to a zoom objective lens.

An intermediate image of the SLM can also be generated in such a way that this intermediate image of the SLM is located inside the light guide at least for a part of the segments of the multiple image of the SLM. However, for another part of the segments, the intermediate image of the SLM can also be located outside the light guide.

Due to this compensation, an intermediate image of the SLM preferably results for all segments at a similar distance for the decoupling of the light out of the light guide. For the case in which intermediate images result in the light guide for all segments, it is then true that for segments having a greater number of reflections in the light guide, the intermediate image in the light guide is farther away from the coupling of the light than for segments having a smaller number of reflections in the light guide.

An astigmatism, which would result in a solely single-step optical system in the imaging of the pixels of the SLM due to the use of grating elements for coupling and decoupling light into or out of, respectively, the light guide, can be at least partially compensated for in the described two-step system. This can take place in that in the two-step optical system, crossed—i.e., arranged perpendicularly in relation to one another—cylindrical imaging elements, such as cylinder lenses, each having variable focal length or controllable grating elements having cylindrical lens functions are used in the intermediate image plane of the virtual observer window, and for each segment of a multiple image of the SLM, the focal lengths of both cylindrical image elements are each set in such a way that a horizontal and vertical image of the SLM visible through the virtual observer window results in a similar depth plane.

In addition, a continuous displacement of the coupling position of the light on the light guide can be carried out by a light deflection device 29, which is arranged in the intermediate image plane ZB of the virtual observer window and/or the illumination device in the immediate vicinity of the variable imaging system 30 in front of the light guide or the light guiding device 26 in the light direction, as shown in FIG. 14. The light deflection device 29 can comprise at least one grating element for this purpose, which is designed to be controllable or variable. The light incident thereon can therefore be deflected accordingly by the light deflection device 29, i.e., the grating element of the light deflection device can be controlled in such a way that the incident light is deflected in a required direction and is thus coupled into the light guide at a different coupling position on the light guide than without this light deflection by the light deflection device 29. FIGS. 12 and 14 both show the illumination beam path. A nondisplaced coupling position in the light guide without light deflection device is shown in FIG. 12. A displaced coupling position in comparison thereto is shown in FIG. 14.

In this manner, various coupling positions of the light on the light guide can be generated. The function of the light deflection device 29 and the function of the variable imaging system 30 can also be combined in one device or system, so that only one device is necessary for both functions. Both lens functions for variable imaging and also prism functions for deflection can be written, for example, in the same controllable grating element.

The position of the image of the SLM in relation to the preferably three-dimensional scene to be generated in particular also has influence on the calculation of the holograms to be encoded into the SLM. Inter alia, the size of a subhologram, where all subholograms form an overall hologram or a hologram, is dependent on how far an object point of a scene is located in front of or behind the image plane of the SLM, which also defines the field of view. If the image of the SLM is located very close to the virtual observer window, through which an observer can then observe the reconstructed or generated scene, subholograms are typically very large in the dimensions thereof. If the image of the SLM, in contrast, is located very far away from the virtual observer window, this can also mean subholograms which are large in the dimensions thereof. A three-dimensional scene may also be represented if there is no image at all of the SLM between the virtual observer window and infinity, but rather instead a real image of the SLM behind the virtual observer window. If the distance of an SLM from an imaging element is greater than the focal length of the imaging element, no virtual image is thus produced. An observer then cannot see a sharp image of the SLM. However, if subholograms are encoded on the SLM itself—i.e., not on its image—the focal length of which is sufficiently long that an object point would be generated, the distance of which from the imaging element is less than the focal length of the imaging element, no virtual image of the SLM is produced, but a virtual image of the object point does. In this case, however, subholograms which are very large in the dimensions thereof are also provided.

In general, an image plane of the SLM can be advantageous which is located within the three-dimensional scene, so that one part of the object points of the scene is located in front of and another part of the object points is located behind the image of the SLM, for example, an image plane which is located at approximately 1 m or 1.5 m distance from the virtual observer window. The computational effort for the computation of the hologram increases with the size of the subholograms.

For example, in a display device having a two-step optical system and a variable imaging system, the position of the image plane of the SLM can be displaced in the individual segments of a multiple image of the SLM in such a way by adapting the focal length of the imaging element of the variable imaging system so that the typical or the maximum size of the subholograms is minimized. The effort for calculating the holograms is then advantageously reduced.

In a display device which does not use a variable imaging system, a calculation of the hologram to be encoded in the SLM can be carried out by a virtual SLM plane, which has a small average size of the subholograms, and an arithmetic transformation into the respective image plane of the SLM for each segment of a multiple image of the SLM. This can also comprise a transformation into a real image plane of the SLM behind the virtual observer window. For example, the virtual plane of the SLM would be identical for all segments of the multiple image of the SLM, but the image plane of the SLM into which transformation is performed is different for each segment in accordance with the image planes generated by the optical system.

The following explanations relate to a backward computation to determine the amplitude and phase of subholograms in consideration of aberrations of the optical system. As already described, aberrations also result in the imaging beam path, for example, due to grating elements for coupling and decoupling light into or out of, respectively, the light guide, which not only cause an undesired displacement of the pixel image of the SLM, but rather also have the consequence that possibly a sharply imaged pixel image of the SLM no longer results at all. In principle, it is possible using a holographic display device to sharply reconstruct three-dimensional object points of a scene in space even if the SLM is not sharply imaged. Under certain circumstances, however, the phase curve of the subholograms then has deviations from a simple spherical lens function, as would typically result for a holographic direct view display or a display having a sharp imaging of the SLM. The amplitude curve of the subholograms can also have deviations from a typical curve, which would be a constant amplitude over the subhologram in the simplest case.

A method will now be described here to check whether the subhologram may be represented correctly on the SLM, and to determine the amplitude distribution and phase distribution in the subhologram which are necessary to reconstruct an object point.

The method can preferably be carried out using software for geometric optical calculation, which simplifies the performance in comparison to a wave-optical calculation in more complex optical systems. Firstly, a calculation of the light propagation from an object point of the preferably three-dimensional scene to the virtual observer window is carried out, as would take place if the object point were actually present in space and an optical system were not located between the object point and the virtual observer window. Therefore, in the case of a wave-optical calculation, a wavefront for light which originates from the object point is calculated in the virtual observer window. In a simplified geometric calculation, light beams are calculated from the object point to various positions in the virtual observer window. A calculation of the wavefront or the light beams then takes place in reverse from the virtual observer window through the optical system to the SLM.

This can be carried out as follows, for example: In the optical calculation a beam splitter element is introduced in front of the virtual observer window in the light direction and a mirror element is introduced at the position of the virtual observer window. Light from an object point of the three-dimensional scene is coupled in at a surface of the beam splitter element, deflected toward the virtual observer window, reflected at the virtual observer window by the mirror element, enters the beam splitter element again and exits through another surface of the beam splitter element and runs from there in reverse through the optical system to the SLM. In this manner, the amplitude distribution and the phase distribution in the subhologram can be determined for an object point.

Alternatively, for example, in the optical calculation, the virtual observer window can be illuminated on the rear and a lens can be arranged in the virtual observer window, which would generate the object point in the absence of the remaining optical system. In order to carry out, for example, the calculation for an object point which is 1 m away from the virtual observer window, the virtual observer window can be illuminated from the rear side using a plane wave and a lens having 1 m focal length can be arranged in the virtual observer window. The amplitude distribution and the phase distribution in the subhologram can also be calculated for an object point in this manner.

For a display device having at least one SLM, multiple imaging elements of the optical system, and a light guiding device, the calculation can be carried out, for example, so that light coming from the virtual observer window enters the light guide of the light guiding device at the decoupling position of the light and leaves the light guide again at the coupling position of the light and then propagates further through the imaging elements of the optical system to the SLM. The position and the size of the subhologram then result by way of the positions at which backwards propagating light beams are incident on the SLM.

FIG. 15 schematically shows a display device having an SLM, imaging elements 27 and 28 of the optical system, a variable imaging system 30, and a light guiding device 26, in which a backward computation is illustrated for determining an amplitude distribution and a phase distribution of an object point. In this case, the backward computation is performed from the virtual observer window VW through the light guiding device 26 to the SLM and the values are determined. An object point to be reconstructed may be correctly represented on the SLM, inter alia, if light beams from all positions within the virtual observer window VW are also incident on the SLM in the backward computation. In addition, the light beams have to be incident on the SLM at an angle which is less than or equal to half of the diffraction angle of the SLM. The diffraction angle results from the wavelength A used and the pixel pitch p of the SLM asλ/p. This condition is generally met if the aberrations in the illumination beam path are small and aberrations are essentially only present in the imaging beam path.

In the case of a wave-optical calculation, an amplitude distribution and a phase distribution of the object point in the subhologram may be defined directly by the backward computation.

In a geometric calculation, the amplitude distribution and the phase distribution are defined as follows:

A geometric backward computation of the light beams is carried out using a very large number of light beams, for example, 100,000 light beams. A relative intensity of a pixel in the subhologram of the SLM then results from the number of the light beams which are incident in the region of the pixels in the SLM. The relative amplitude can be calculated as the square root of this intensity. For absolute values of the amplitude, the sum of all intensities of the pixels in the subhologram is set equal to the intensity of the object point. Since the amplitude generally continuously varies in the subhologram, it does not have to be individually calculated for each pixel, but rather can also be interpolated on the basis of sample points in a simplified form.

FIG. 16 schematically illustrates an intensity distribution in the plane of the SLM as would result by way of a backward computation as per the geometrical calculation according to FIG. 15. It shows an intensity distribution in a subhologram. The illustrated subhologram approximately has a triangular shape in this example and has an approximately sickle-shaped narrow region having high intensity at the lower edge. It deviates significantly from a conventional subhologram on an SLM, which would have a rectangular shape having constant amplitude over the area of the subhologram. The calculation of phase values can be carried out in particular if a unique association exists between a position on the SLM and the entrance angles of the light beams into the SLM. This means light beams cannot be incident at the same position in the SLM at significantly different angles. A lens function written into a subhologram can be considered to be a diffraction grating having a grating period varying over the position. For each two adjacent pixels of the SLM, the deflection angle of the light therefore locally corresponds to a local grating period, whereby the difference of the phase values of the two pixels can be defined. If a phase value is therefore defined for a first pixel, a phase value, which corresponds to the desired difference, can also be defined for each of the adjacent pixels. The phase values may thus be defined step-by-step starting from one pixel to each of the adjacent pixels.

Therefore, firstly a local grating period is determined in the geometrical backward computation from the angle of incidence of a light beam on the SLM. According to the equation tanα=λ/g, where α is the angle of incidence of the light beam and λ is the wavelength of the light, the local grating period g is defined as g=λ/tanα. Then, Δφ=2*πp/g, where p is the pixel pitch of a complex-valued pixel of the SLM, represents the phase difference of two adjacent pixels, which is necessary to set this deflection angle. Therefore, if a first pixel has the phase value φ0, the second pixel thus receives the phase value φ0+Δφ.

With a two-dimensional pixel arrangement of the SLM, the angle of incidence is decomposed in this case into a horizontal component and a vertical component. The above-mentioned equations are then respectively used to determine a local horizontal grating period and a vertical grating period. The phase difference of adjacent pixels is determined from the local grating period from the ratio 2*π*p/g having the pixel pitch p of a complex-valued pixel. For example, if the angle of incidence of a light beam on the SLM corresponds to half the diffraction angle, a phase difference of τ thus results between adjacent pixels. If the angle of incidence of a light beam on the SLM corresponds, for example, to one-fourth of the diffraction angle, a phase difference of π/2 thus results. The phase curve in the subhologram is then defined using the phase differences and a selectable offset phase value. For example, this offset phase value can be defined so that the phase value of the pixel in the top left corner of the subhologram is set to 0. Since the local grating period in the subhologram generally varies continuously, it also does not have to be individually calculated for each pixel pair, but rather can be interpolated on the basis of sample points. The phase thus determined corresponds to the phase in the subhologram for an SLM which is illuminated using a plane wave. If the illumination wavefront deviates from a plane wave, this illumination wavefront is thus also subtracted from the phase values for the subhologram.

The phase distribution of the illumination wavefront can optionally, analogously to the above description, be determined from a geometrical optical calculation and the angles of incidence of light beams from the illumination device on the SLM. Such a calculation can also be performed off-line and the determined values can then be stored in a lookup table for the hologram calculation.

As already explained, a two-step optical system is preferably used in a display device, which generates an intermediate image plane of the illumination device. In one exemplary embodiment having such a two-step optical system, a variable imaging system can be provided in the intermediate image plane of the virtual observer window. The variable imaging system can comprise in this case, for example, a grating element having controllable variable period (LCG).

An exemplary embodiment was also already described in which, in a two-step optical system having an intermediate image of the illumination device, a light deflection device is arranged in an intermediate image plane of the illumination device to displace the coupling position of the light in the light guide by writing a prism function into at least one grating element of the light deflection device. This grating element can also be designed, for example, as a grating element having controllable period. Both, variable imaging system and light deflection device, can also again be combined here in a single device.

A further exemplary embodiment of a display device having a two-step optical system is described hereafter. In this case, in at least one grating element of the variable imaging system and/or the light deflection device, where the grating element is a phase-modulating element, for example, a grating element having a controllable variable period (LCG), alternatively or additionally to a simple lens function or prism function, a complex phase characteristic can also be written to be able to compensate for aberrations. For example, this can be carried out in combination with the above-described backward computation from the virtual observer window through the light guide in the direction of the SLM. However, a backward computation then takes place firstly only from the virtual observer window to the intermediate image plane of the illumination device. In particular if aberrations fundamentally only exist in the imaging beam path and no or only small aberrations exist in the illumination beam path, in the backward computation, light beams in the intermediate image plane of the illumination device have essentially the correct position, but because of aberrations, the incorrect angle in comparison to the target position and target angle in the actual virtual observer window. Therefore, for individual light beams, the angles can be corrected by a corresponding local grating element in the intermediate image plane of the illumination device. For example, if β (x) is the desired angle of incidence of the light beam at the position x, β′ (x) is the actual angle of incidence of the light beam at the position x, the correction value is then Δβ (x)=β(x)−β′ (x). The position and the desired angle of incidence of the light beam correspond to those in the actual virtual observer window in consideration of the imaging scale from the intermediate image plane of the illumination device to the virtual observer window. Similarly as already described for the backward computation in the SLM, the local grating period is then defined as g(x)=λ/tan Δβ (x). The advantage of a correction of aberrations in the imaging beam path by a phase function in an intermediate image plane of the illumination device is that this correction is independent of the content of the three-dimensional scene. The correction function and/or the correction value can therefore be respectively calculated once for each segment of the multiple image of the SLM and also for a selection of possible decoupling positions in the case of a continuous displacement of the coupling position of the light and stored in a value table, so that these values can be used again and again accordingly when needed.

The above-described aberration correction of the subholograms in the SLM plane by a backward computation to the SLM represents the case that by way of a suitable amplitude curve and phase curve in the subholograms, object points in space can be generated as sharp points even if there is no sharp image of the pixels of the SLM. The use of a variable imaging system in the intermediate image plane of the illumination device, which is also described, does displace the image of the SLM, but nonetheless a blurred image can be present.

In comparison thereto, the image of the SLM itself is improved by the aberration correction now described in the intermediate image plane of the illumination device. The image of the SLM pixels becomes sharper and therefore the subholograms for reconstruction of the object points can be more similar to a lens function having constant amplitude as would also be present in a direct view display. Therefore, the computational effort for the calculation of the holograms also decreases because of the subholograms, which are smaller in the dimensions thereof. Both methods, an aberration correction in the intermediate image plane of the illumination device and an aberration correction in the amplitude curve and phase curve of the subholograms, can also be combined with one another, however.

For example, a backward computation and an aberration correction are then carried out in the intermediate image plane of the illumination device in such a way, as shown in FIG. 17, that firstly the light path for an object point in the center of the field of view section of a single segment of a multiple image of the SLM and at a distance from the virtual observer window which corresponds to the target distance of the SLM image from the virtual observer window to the intermediate image plane of the illumination device is calculated. With a sharply imaged SLM, the subhologram would then only be one pixel in size, since the object point is located in the display plane. The local grating period of the grating element of the variable imaging system and/or the light deflection device in the intermediate image plane ZB of the illumination device is set in such a way that during the further backward computation to the SLM, the light beams run together there in one pixel in the center of the SLM. FIG. 17 shows this on the basis of the example of five light beams which run from various positions in the virtual observer window (not shown here) through the light guide or the light guiding device 26 and the imaging element 28 to the intermediate image plane ZB of the illumination device and from there, after matching setting of the grating period of the grating element provided there, further through the imaging element 27 to the SLM. For object points at a different distance from the virtual observer window but still in the central region of the field of view section of the segment of the multiple image of the SLM, subholograms then result as simple lens functions having a focal length of the distance of the object point. However, if the same correction is used in the intermediate image plane ZB of the illumination device for object points which are located at the edge of the partial field of view of the segment, residual aberrations can nonetheless thus still exist in the SLM plane. For this purpose, as already described for the further correction of the still existing aberrations, the angle of incidence in the hologram plane is determined and phase functions for the subhologram are calculated therefrom. Expressed in simplified form, subholograms are used as a lens function without correction in the middle region of the SLM subholograms, because the pixel image is sharp there, but in the edge region of the SLM, subholograms having an additional aberration correction in the SLM plane are used, because the pixel image is less sharp there. Overall, however, the required aberration correction of the subholograms in the SLM plane is also substantially reduced in this case by the use of a correction in the intermediate image plane of the illumination device.

As already described for the use of a variable imaging system in the intermediate image plane of the illumination device, this embodiment can be replaced by an alternative embodiment, i.e., the variable imaging system is replaced by a calculation in a virtual SLM plane, transformation into the virtual observer window, and back transformation into the actual SLM plane, in this case the plane of the actual image of the SLM. During this transformation from the virtual SLM plane into the observer plane having the virtual observer window and from there into the plane of the SLM image, quadratic phase terms are added to the phase value in the observer plane in accordance with the distances from the two planes (SLM plane, observer plane). These quadratic phase terms are an equivalent for a lens function. The use of a variable imaging system in an intermediate image plane of the illumination device and thus also intermediate image plane of the virtual observer window for displacing the SLM image as a method or instead the arithmetic transformation of the object point into an observer plane and adding on quadratic phase terms to the phase value in this plane and back transformation for the purpose of the arithmetic displacement of the SLM image between a virtual plane of the SLM and the actual image plane of the SLM are alternative options for an aberration correction.

However, it can be advantageous for an aberration correction if alternatively or additionally to the use of a variable imaging system having phase elements in an intermediate image plane of the illumination device, a correction is also carried out in the form of an arithmetic transformation. The subholograms are thus calculated in a virtually aberration-free image plane of the SLM, they are transformed from there arithmetically into the intermediate image plane of the illumination device. In this intermediate image plane, a reciprocal aberration correction is performed and the corrected data are thus back-transformed into the actual aberration-afflicted image plane of the SLM. A combination of an arithmetic correction and a correction by means of phase elements is reasonable, for example, if grating elements having variable controllable period but one-dimensional electrode structures are used. If two crossed grating elements are used in the variable imaging system or in the light deflection device, for example, a phase curve which is dependent only on the horizontal coordinate or only on the vertical coordinate can be corrected by hardware in one grating element in each case. Further phase terms or phase functions which are not horizontally and vertically independent can be taken into consideration in the form of a two-dimensional matrix of phase values in an additional arithmetic correction. For this purpose, firstly a calculation of the correction as a phase curve is carried out and then a decomposition of the phase curve into individual components ph(x,y)=ph1(x)+ph2(y)+ph3(x,y).

The correction values can also be determined by a backward computation from the virtual observer window via angles and local grating periods in the case of an arithmetic consideration of the aberration correction, as if a correction element were physically present in the intermediate image plane of the illumination device.

FIG. 18 schematically shows the head 31 of an observer, in which a display device having a light guiding device 26 is arranged in each case in front of a right eye RA and a left eye LA. Both display devices form a so-called head-mounted display (HMD), which is attached to the head 31 of the observer. For better comprehension, the beam path of the respective display device is illustrated unfolded. However, to provide a suitable HMD, the beam path of both display devices would be a folded beam path in practice. For this purpose, for example, deflection mirrors can be provided between the SLM and the light guiding device 26, so that in each case the SLM and the imaging elements of the optical system are arranged laterally adjacent to the head 31 of the observer. In each case light is coupled into the light guiding device 26 provided in front of the respective eye LA, RA from the outer side of the head 31, propagates therein, and is decoupled by the light decoupling device 25 out of the light guide of the light guiding device 26 in the direction of the eye RA, LA of the observer. The respective virtual observer window then results on the pupil of the eye RA, LA, so that the observer can observe a generated or reconstructed scene. In FIG. 18, a curved light guide is used in the light guiding device 26. In principle, tracking of the virtual observer window is not required in an HMD, since the HMD is fixedly connected to the head 31 of the user and therefore larger position changes of the user do not occur. This is because if the user moves, the HMD is simultaneously also conveyed to this position. However, under certain circumstances it can be reasonable for fine tracking of the virtual observer window if an observer tracking device is preferably provided after the light guiding device in the light direction, which comprises at least one liquid crystal grating element, for example, and is designed for tracking the virtual observer window at least in one direction, preferably the horizontal direction.

The use of grating elements will be mentioned and described here in various contexts. A display device, for example, an HMD, typically requires the use of multiple wavelengths, for example, red, green, and blue, for a colored reconstruction or representation of a scene. For this purpose, it can be provided, for example, that light of various wavelengths is applied sequentially in time to the grating elements and in particular in the case of grating elements having settable period, they are set separately for each wavelength; or if grating elements are used, for example, as coupling grating element and decoupling grating element, for guiding the light into or out of, respectively, the light guide, grating elements having a sufficient wavelength selectivity are used, so that, for example, they only act as a grating element for one wavelength. In the general case, a stack of multiple grating elements is also to be understood as a coupling grating element according to the invention, for example, a stack of three grating elements, one grating element for each primary color red, green, blue (RGB) or each wavelength.

The above description of the invention in general and also of exemplary embodiments relate above all to display devices which have a light guide and/or a light guiding device. However, it is to be noted here for clarification that in particular the portions of the description which relate to a two-step optical system and also a determination of subholograms by backward computation are also applicable more generally to holographic or stereoscopic display devices which do not have a light guide or light guiding device. In general, a display device having a two-step optical system is to be described, in which an SLM is illuminated by an illumination device and an intermediate image of the virtual observer window is generated by at least one first imaging element of the optical system in an intermediate image plane of the illumination device. This intermediate image of the virtual observer window is imaged in the position of the actual virtual observer window by at least one second imaging element of the optical system. In this case, a variable imaging system, which comprises at least one imaging element, is arranged in the intermediate image plane of the illumination device. Prism functions and/or lens functions and/or phase curves for aberration correction can be written into the at least one imaging element.

The above-described arithmetic aberration correction in the intermediate image plane of the illumination device can also be carried out in general for a two-step optical system even without the use of a light guide or a light guiding device.

The general display device can also be, for example, a holographic projection system, in which a real image of the SLM is generated on a screen, or also a head-mounted display, which has other components such as conventional lenses or mirrors instead of a light guide.

Such a display device can advantageously be combined with a system as described, for example, in the application PCT/EP2017/071328 of the applicant in FIGS. 7 and 8, where filtering is performed using a filtering element in an intermediate image plane of the illumination device. This filtering is used, for example, to filter out the zero order spot or to filter out specific diffraction orders. The content of the disclosure of this application is to be incorporated here in its entirety. Accordingly, a passive or variable amplitude element for filtering in the intermediate image plane of the illumination device can be combined with the at least one phase element of the variable imaging system proposed here to implement prism functions or lens functions or for aberration correction. Furthermore, besides filtering, an amplitude element can additionally be used for aberration correction.

A lateral displacement of the virtual observer window over one or two diffraction orders, as described in PCT/EP2017/071328 of the applicant, can also be combined with the two-step optical system described here having a variable phase element in the intermediate image plane of the illumination device. If, for example, a lens function for displacing the SLM image in the depth is to be implemented having the phase element or grating element of the variable imaging system for a laterally displaced position of the virtual observer window, the phase element or the grating element is to be as large in its dimensions as the entire region coming into consideration, i.e., as multiple diffraction orders in the intermediate image plane of the illumination device. The position in which a lens function is written into the grating element can also be laterally displaced on this grating element and the dimensions of the region on the grating element in which the lens function is written only have to be as large as the region corresponding to the observer window, i.e., at most as large as one diffraction order. The other diffraction orders can be filtered out, for example, by filtering in the intermediate image plane of the illumination device. For example, it can be a controllable filter device, using which various diffraction orders can alternately be filtered out or transmitted. In the case of a backward computation from the virtual observer window, for example, for aberration correction, only a section of the size of at most one diffraction order, which is displaced accordingly, is also used for the calculation of the correction. In the case of an arithmetic correction in a laterally displaced virtual observer window, this can be taken into consideration by corresponding linear phase terms in the hologram plane or in the SLM plane in the calculation.

In general, it is also possible to use an additional grating element having controllable variable grating period close to the SLM, using which the position of the intermediate image of the observer window is displaced in the intermediate image plane of the illumination device by writing into a prism function, and to use a larger phase element or grating element of a variable imaging system in this intermediate image plane, the dimensions of which are sufficiently large that it comprises the entire possible region by which the intermediate image of the observer window can be displaced, in which a phase function of prism functions or lens functions or a phase function for aberration correction is only written locally in the region of the present position of the intermediate image of the virtual observer window.

The backward computation from the virtual observer window through an optical system to the SLM is also generally applicable, not only for an optical system in conjunction with a light guide and/or a light guiding device and/or for a two-step optical system. However, the combination of the method of the backward computation with a two-step optical system, which incorporates a light guide—in particular a curved light guide—in the second imaging step and which comprises a variable imaging system, which can be controllable, in the intermediate image plane of the illumination device and in which the backward computation is used to determine an aberration correction which is written into the form of a phase function in the variable imaging system, is particularly advantageously applicable.

The following explanation in general especially discusses angles in the light guide and the calculation of the decoupling position on the light guide of the light guiding device. The path which a light beam has covered after a defined number of reflections in a light guide may be calculated on the basis of the geometry of the light guide and the optical properties of the light coupling device and the light decoupling device.

In FIG. 19, an example of a plane or planar light guide LGA is illustrated in illustration (a) and an example of a curved light guide LGB is illustrated in illustration (b). In FIG. 19 a), light L is coupled into a light guide LGA of the thickness d in such a way that it propagates at an angle β in relation to the normal of the light guide LGA. The light L then reaches the surface opposite to the coupling side after a distance Δx=dtanβ from the coupling position and again reaches the surface at which the light was coupled in after twice the distance 2Δx=2dtanβ. If the light beam L is accordingly decoupled out of the light guide LGA again after N reflections, the distance between coupling side and decoupling side is thus: 2Ndtanβ.

In FIG. 19 b), the light propagation is illustrated in a curved light guide LGB, which represents the section of a circular arc. The inner surface has a radius r1 around the circle center point K and the outer surface has a larger radius r2 around the circle center point K. The thickness of the light guide LGB is d=r2−r1, therefore the difference of the two radii r1 and r2. Light L which is coupled in so that it propagates at an angle β in relation to the normal on the inner surface in the light guide LGB is incident because of the different radii r2 and r1 on the outer side of the light guide LGB at a different angle β−γ/2 in relation to the normal. After a reflection on the outer side of the light guide LGB, the light beam L again reaches the inner side, after it has covered an angle segment on the circular arc of γ. The following relationship results from the law of sines:

γ=2*(β−asin(sin(β)r1/r2)).

A numeric example: For an inner radius of the light guide of 32 mm and an outer radius of 36 mm at an angle β of 51.9°, an angle γ of the section of the circular arc of 15° results for a reflection of the light on the outer side of the light guide until the light is incident on the inner side of the light guide again. For four reflections of the light in the light guide, the light would propagate, for example, 60° on the circular arc in the light guide. From the above equation, the decoupling position on the light guide after a defined number of reflections can thus also be calculated for the case of a curved light guide from a known coupling position on the light guide and the angle β.

For coupling of the light into the light guide using a grating element, the known grating equation: sinβₒᵤₜ=λ/g+sinβᵢₙ results, where λ is the wavelength, g is the grating constant of the grating element, βᵢₙ is the angle of incidence of the light, and βₒᵤₜ is the resulting angle of the light at which the light then propagates in the light guide. The grating equation applies in this form if entry medium and exit medium are identical. For the incidence of light from air and the propagation in the light guide having the index of refraction n, the refraction on the boundary surface of the two media is additionally also to be taken into consideration: sinβ_{inmed}=1/n sin βᵢₙₐᵢᵣ, where β_{inmed} is the angle of incidence of the light on the grating element in the medium having index of refraction n and βᵢₙₐᵢᵣ is the angle of incidence of the light in air

FIG. 20 illustrates a plane or planar light guide LG, in which it is now taken into consideration that different light beams of a light bundle are coupled into the light guide LG at different locations or positions. These different coupling positions differ in this case by the distance Δxᵢₙ. As is apparent from FIG. 20, by way of example, two light beams L1 and L2 having different angles α1 and α2 in air are incident on the coupling grating element Gᵢₙ. Therefore, these light beams L1 and L2 are also deflected by this coupling grating element Gᵢₙ at different propagation angles β1 and β2 in the light guide LG.

In a display device, an angle spectrum for the coupling of the light into the light guide can result, for example, from the angle of diffraction of an SLM having a predetermined pixel pitch. By suitable positioning of a decoupling grating element on the light guide, it would be possible in the present case to decouple both light beams L1 and L2 out of the light guide again after either one, two, or three reflections in the light guide. FIG. 20 shows the position of a decoupling grating element Gₒᵤₜ for two reflections (N=2) of the light at the boundary surfaces of the light guide LG. A decoupling of the light out of the light guide LG after four reflections at the boundary surfaces of the light guide would be made more difficult in the example illustrated in

FIG. 20 in that the light beam L1 extending at the smaller angle β1 reaches the same position P on the boundary surface of the light guide after four reflections as the light beam L2 extending at the greater angle β2 after three reflections of the light at the boundary surfaces of the light guide LG. If a decoupling grating element were provided at this position, the case could thus occur that inadvertently the light beam L2 extending at the angle β2 will already be decoupled after three reflections in the light guide, therefore too early. Such disadvantageous overlaps of the decoupling regions can be avoided for a given size of a light bundle to be coupled in and a given angle spectrum of the light to be coupled in, for example, by way of a suitable selection of the thickness of the light guide and the grating constant of the coupling grating element.

In the following description, the grating elements in the light coupling device and the light decoupling device are discussed more extensively and explained in greater detail.

As already mentioned, a light decoupling device for decoupling light out of a light guide of the light guiding device can alternately comprise controllable grating elements or also passive grating elements in combination with polarization switches. However, it is also possible that the light decoupling device only comprises passive grating elements.

A display device, in which a multiple image of an SLM composed of segments is generated by a light guiding device, requires switchable grating elements or passive grating elements in combination with polarization switches. A display device in which only a single image of an SLM, which is therefore not composed of segments, is generated by a light guiding device can also only comprise passive grating elements without additional switch element in specific configurations. Specific configurations of a light decoupling device which are usable in light guiding devices for such display devices are described more extensively hereafter.

A light coupling device can also comprise grating elements. Specific arrangements of grating elements may also be used in similar form both for the light coupling device and also for the light decoupling device. The controllable or passive grating elements can alternately be designed as transmissive or reflective. They can alternately be arranged on an inner boundary surface, for example, between light guide core and an outer layer, such as a dielectric layer stack, or on an outer surface of the light guide. A light decoupling device can also comprise a combination of reflective and transmissive grating elements. In a display device having a light guiding device, transmissive grating elements are preferably arranged on a boundary surface or surface of the light guide facing toward an observer and reflective grating elements are preferably arranged on a boundary surface or surface of the light guide facing away from the observer in the light decoupling device. The light coupling device can also inversely have transmissive grating elements preferably on a surface or boundary surface facing away from the observer and reflective grating elements preferably on a surface or boundary surface of the light guide facing toward the observer in a display device.

Grating elements generally have a dependence of the angle of deflection thereof on the wavelength. The same grating element would typically deflect red light at a greater angle than green or blue light. For a display device having a light guiding device, light of different wavelengths, for example, red, green, and blue light (RGB) is advantageously also to be decoupled at the same position or location out of the light guide after an equal predefined number of reflections of the light within the light guide. In addition, the light of different wavelengths is then also to propagate from the decoupling position of the light guide at the same angle to an observer region, i.e., to a virtual observer window or sweet spot. This may be implemented most easily if the coupling angle and decoupling angle of the light are equal for the wavelengths used (red, green, blue (RGB)). For the coupling of the light into the light guide it is possible, for example, to also use a mirror element, using which coupling angles can be implemented independently of the wavelength, instead of a grating element.

A use of grating elements for coupling or decoupling of light into/out of the light guide and an implementation of equal angles for various colors or wavelengths requires either the use of different grating elements for the individual wavelengths or a single grating element, the grating period of which is settable for the individual colors. Volume gratings are known for the fact, for example, that they can have a restricted angle selectivity and wavelength selectivity. It is possible, for example, to generate volume gratings which advantageously essentially deflect either only red light or only green light or only blue light, since they have a very low diffraction efficiency at the respective other wavelengths.

The light coupling device or also the light decoupling device can comprise a stack made of three grating elements, for example, a volume grating for red light, a volume grating for green light, and a volume grating for blue light. These three volume gratings are designed so that they each also deflect red, green, and blue light, which is incident at the same angle on the volume grating, at the same angle. It is also known that it is possible with volume gratings to expose multiple grating functions in a single layer. Instead of a grating element stack, the light coupling device or also the light decoupling device could therefore also comprise a single grating element having multiple exposed grating functions for the deflection of red, green, and blue light. In the case of a grating element stack, all grating elements can optionally be designed as switchable and/or controllable. However, multiple passive grating elements are then preferably used in combination with a single switch element, for example, a polarization switch.

Another possibility to achieve the same angle of deflection in the coupling and decoupling of the light for various wavelengths is the use of a grating element which deflects multiple wavelengths at different angles, in combination with corrective grating elements, which each correct the angle of deflection for a single wavelength so that this angle of deflection corresponds to the angle of deflection for another wavelength. In such a light coupling device or light decoupling device, for example, a first grating element for deflecting multiple wavelengths can be designed as a surface relief grating or as a polarization grating, while further grating elements for correcting the angle of deflection of one wavelength each can be designed as volume gratings. The first grating element deflects, for example, red, green, and blue light, where the green light is deflected at the desired angle, but the red light is deflected at an excessively large angle and the blue light is deflected at an excessively small angle. The further provided grating elements then carry out a correction of the angle of deflection for blue and red light so that red, green, and blue light are coupled at the same angle of deflection into the light guide and also decoupled again. For the correction of the angle of deflection for each wavelength, more than one grating element can also be used per wavelength, for example, an arrangement of volume gratings having two grating elements in each case per wavelength. A first volume grating for correcting the angle of deflection can carry out a pre-deflection in each case. A second volume grating can then deflect the pre-deflected light in such a way that the desired exit angle is implemented or results. The fact is utilized in this case that volume gratings having large angle of deflections generally have a narrower wavelength selectivity than volume gratings having small angle of deflections. It is easier to achieve the volume gratings only deflecting light of one wavelength by way of a narrower wavelength selectivity.

In particular, the first grating element of the light coupling device or light decoupling device for deflecting multiple wavelengths can be designed as switchable and/or controllable. The further grating elements for correcting the angle of deflection of one wavelength each can be designed as passive. However, it is also possible that all grating elements of the light coupling device or light decoupling device are designed as passive. If a switchable element or a switch element is required with respect to the decoupling of the light, the passive grating elements can then again be combined with a polarization switch as a switch element. However, all grating elements can alternatively also be designed as switchable and/or controllable.

In configurations of the light decoupling device in which passive grating elements are used in combination with switch elements, for example, polarization switches, either at least one grating element itself is to be designed as polarization-selective, i.e., only deflect light of a defined polarization, or an additional polarization element is to be arranged between the polarization switch and the grating elements.

In configurations of the light decoupling device having only passive grating elements without switch element, in which, however, only light of a defined polarization is to be decoupled, at least one grating element is to be designed as polarization-selective itself, or an additional polarization element is to be arranged between the polarization switch and the grating elements.

A combination of polarization selectivity, wavelength selectivity, and angle selectivity may be achieved, for example, using specific types of volume gratings. Volume gratings having a grating structure made of liquid crystal material which has birefringence, and an isotropic material, which has the same index of refraction as either the ordinary or the extraordinary index of refraction of the liquid crystal material, can act for a first linear polarization like a grating and for a second linear polarization perpendicular thereto like an isotropic material. Examples of such gratings are polymer dispersed liquid crystal (PDLC) gratings, polyphems gratings, or POLICRYPS (polymer liquid crystal polymer slices) gratings. These gratings are referred to hereafter as polarization-selective volume gratings (PSVG). Polarization-selective volume gratings based on liquid crystals can also be designed as switchable, by the grating being arranged between two electrodes and the orientation of the liquid crystals being changed by an electric field. In a first switching state, which is referred to hereafter as ON, these gratings have a deflecting effect for light of a linear polarization, typically p-polarized light, but have a non-deflecting effect for a linear polarization rotated by 90° thereto, typically s-polarization. In a second switching state, referred to hereafter as OFF, these gratings do not have an effect for s-polarization or for p-polarization. Specific types of switchable polarization-selective volume gratings are sometimes also referred to in the literature as “switchable Bragg gratings (SBG)”. In this document, the designation PSVG is also used for this purpose. A further type of grating which can have a high diffraction efficiency in a single diffraction order is a polarization grating (PG). Conventional polarization gratings deflect, for example, left-circular polarized light in a +1. diffraction order and right-circular polarized light in a −1. diffraction order or vice versa, depending on the design of the grating. In contrast to volume gratings, conventional polarization gratings have a wide angle acceptance and a high efficiency for various wavelengths. Special types of polarization gratings having small grating period have the property, however, that they only deflect light of a defined circular polarization, but transmit light of the circular polarization having opposing rotational direction undeflected. For differentiation from the polarization-selective volume gratings (PSVG) and the conventional polarization gratings, (PG) they are referred to hereafter as Bragg polarization gratings (B-PG). These gratings will be described in greater detail hereafter.

In one configuration of the light decoupling device having an additional polarization element, a wire grid polarizer (WGP) is provided on the inner or outer cladding layer of the light guide. Wire grid polarizers are also available as films and can also be laminated, for example, onto curved surfaces, such as the cladding layer of a curved light guide. Grating elements are provided or applied on the outer surface of the wire grid polarizer. A wire grid polarizer has the property that it reflects light of a first linear polarization and transmits light of a second linear polarization perpendicular thereto. Light of a first polarization is thus reflected from the wire grid polarizer on the cladding layer of the light guide and then propagates further in the light guide, therefore does not reach the grating element at all. Light of a second linear polarization perpendicular thereto passes through the wire grid polarizer and is incident on at least one grating element, for example, a grating element stack made of three volume gratings, and can be deflected from the grating element or one of the grating elements, if a grating element stack is provided, and decoupled out of the light guide.

As already mentioned, switchable or controllable grating elements or also polarization switches for use in combination with passive grating elements can be divided into sections, so that the individual sections each have separate electrodes, using which a switching of the polarization can be performed in sections by applying an electric field. The term “section” is also to comprise rough structures according to the invention. For example, the switchable or controllable grating elements or switch elements, for example, polarization switches, can only be divided into three or four rough sections, which each have individual electrodes and are multiple millimeters wide, for example, 5 mm-10 mm. A finer division into multiple small sections is also possible, however, for example, into strip-shaped sections of 0.5 mm width.

A division of the switchable or controllable grating elements or the switch elements into sections can be provided or used as follows in a display device, in which either a single image or a multiple image composed of segments of an SLM is generated by means of a light guiding device:

In one embodiment of the display device, the number of the reflections of the light within the light guide up to the decoupling is set by means of switching on and switching off specific sections of the switchable or controllable grating elements or at least one switch element. It can also be provided for this purpose that specific sections are set into one driving state and other sections are set into another driving state to vary or change or define the number of reflections of the light within the light guide.

In another embodiment of the display device, the decoupling position of the light is also varied in fine steps by means of switching on and switching off specific sections of the switchable or controllable grating elements or at least one switch element or also with various driving states of the sections for a fixed number of reflections of the light at the boundary surfaces of the light guide. This can be used, for example, to displace the position of a single segment of a multiple image of an SLM in fine steps. This can be used, for example, in combination with gaze tracking to position a specific segment of the multiple image in the center of the gaze direction of an observer.

FIG. 21 schematically illustrates a light guiding device having a light guide LG and a light decoupling device, in which a polarization switch PS is provided on one side in the light decoupling device. The polarization switch PS itself can be constructed, for example, from a liquid crystal layer between electrodes, to which an electric field can be applied. In this case, left-circular polarized light CL initially propagates in the light guide LG, where, as is apparent, the left-circular polarized light CL is coupled into the light guide LG on the left side in FIG. 21 and propagates to the right side via total reflection in the light guide LG. As can furthermore be seen from FIG. 21, the polarization switch PS is divided into two sections, which are referred to hereafter for the sake of simplicity as a left section and a right section. In the left section, which corresponds to the left side of FIG. 21, the polarization switch PS is controlled so that it does not change the polarization of the incident light. This left section is in an OFF state. In the right section, the polarization switch is controlled so that it changes the polarization of the incident left-circular light CL, so that after passage of the light through this right section of the polarization switch PS, right-circular light CR is provided. The right section of the polarization switch PS is in an ON state.

On the outer side of the light guide LG, i.e., after the polarization switch PS, a polarization grating element having volume grating properties is arranged, thus a Bragg polarization grating

B-PG. This Bragg polarization grating B-PG has the property that it deflects right-circular polarized light CR by an angle which is defined by the grating period of the Bragg polarization grating B-PG, but does not deflect left-circular polarized light CL. Additional carrier substrates, for example, made of plastic, can be provided between the polarization switch PS and the Bragg polarization grating B-PG and also between the Bragg polarization grating B-PG and the outer surface of the light guiding device. Such carrier substrates are shown in FIG. 21, but are not required.

In operation of the light guiding device, the left-circular polarized light CL passing through the left section of the polarization switch PS is then incident on the Bragg polarization grating B-PG, passes through it undeflected and is incident on the boundary surface of the light guide LG of the light guiding device in such a way that a total reflection TIR takes place. The light then propagates further in the light guide LG. The right-circular polarized light CR passing through the right section of the polarization switch PS is incident on the Bragg polarization grating B-PG, is deflected accordingly by this Bragg polarization grating B-PG, is therefore incident perpendicularly on the boundary surface of the light guide LG to the surrounding medium air, and is coupled out of the light guide LG. As already described, correction grating elements can also follow the Bragg polarization grating B-PG for decoupling light of multiple wavelengths out of the light guide at the same angle in the light guiding device.

FIG. 22 schematically shows a light guiding device, which comprises a wire grid polarizer WGP in the light decoupling device. Linear s-polarized light S propagates here in the light guide LG of the light guiding device. The provided polarization switch PS is also divided again here into two sections, into a right section and a left section. In a driving state or in the switched-on state ON of the left section of the polarization switch PS, it changes the incident s-polarized light S into p-polarized light P. As can be seen in the right section of the polarization switch PS, which is in an OFF state, the incident s-polarized light S passes through this section unchanged, so that thereafter s-polarized light S is still present. The s-polarized light S is thereafter incident on the wire grid polarizer WGP. The wire grid polarizer WGP reflects the s-polarized light S, which then propagates further in the light guide LG, as indicated by the arrow. In contrast thereto, the p-polarized light P converted by the left section of the polarization switch PS passes through the wire grid polarizer WGP and is incident on a quarter-wave plate QWP. The quarter-wave plate QWP converts the incident p-polarized light P into right-circular polarized light CR, where the right-circular polarized light CR is then incident on the Bragg polarization grating B-PG. The right-circular polarized light CR is deflected by this Bragg polarization grating B-PG, is then incident perpendicularly on the boundary surface of the light guide LG to the surrounding medium air and is coupled out of the light guide LG. The advantage of a light guiding device constructed in this manner is that imperfect behavior of the polarization switch PS and of the quarter-wave plate QWP can be compensated for.

If less than 100% of the light is changed by the polarization switch PS from s-polarized light to p-polarized light, this light is thus reflected at the wire grid polarizer WPG. If less than 100% of the light is changed by the quarter-wave plate QWP into circular polarized light, this light is thus reflected at the boundary surface by total reflection and also propagates further in the light guide LG. Interfering light having the incorrect polarization is thus prevented from also being

This light guiding device can also be used in combination with correction grating elements for other wavelengths of the primary colors RGB, so that light of various wavelengths is coupled out of the light guide at equal angles.

A light guiding device is schematically illustrated in FIG. 23 which also comprises a wire grid polarizer WGP in a light decoupling device, like the light guiding device of FIG. 22. Instead of a Bragg polarization grating B-PG, the light decoupling device of the light guiding device now comprises a volume grating VG. A quarter-wave plate is not provided here. The light passage through the light guide LG and the light decoupling device takes place similarly as in FIG. 22. As is apparent, the s-polarized light S is already reflected at the wire grid polarizer WGP if a section of the polarization switch PS is in an OFF state. If a section of the polarization switch PS is in an ON state, the s-polarized light S incident thereon is converted into p-polarized light P, passes through the wire grid polarizer WGP, and is incident on the volume grating VG. In this exemplary embodiment, the volume grating VG itself is not designed as polarization-selective. It can be, for example, a volume grating made of conventional photopolymer material. The p-polarized light P is deflected by the volume grating VP, is then incident perpendicularly on the boundary surface of the light guide LG to the surrounding medium air, and is coupled out of the light guide LG.

A light guiding device having a light decoupling device is schematically illustrated in FIG. 24, which differs from FIG. 23 only in that the volume grating VG is designed as reflective. In the OFF state of the polarization switch PS, the incident s-polarized light S is reflected at the wire grid polarizer WGP and propagates further in the light guide LG. However, if a section of the polarization switch PS is in an ON state, the incident s-polarized light is converted by the polarization switch PS into p-polarized light P, passes through the wire grid polarizer WGP, and is incident on the reflective volume grating VG. The p-polarized light P is deflected and reflected by the volume grating VG. The reflected p-polarized light P then passes once again perpendicularly through the light decoupling device and the light guide LG and is coupled out of the light guide LG on the opposite side.

A light guiding device is schematically illustrated in FIG. 25, in which the light decoupling device comprises a switchable polarization-selective volume grating PSVG, for example, based on liquid crystals. If the switchable polarization-selective volume grating PSVG is in a certain driving state or in an OFF state, both s-polarized light S and also p-polarized light P which is incident on the switchable polarization-selective volume grating PSVG is not deflected, but rather is reflected at the boundary surface of the light guide LG by means of total reflection and then propagates further in the light guide LG, as shown by the far left arrow. However, if the switchable polarization-selective volume grating PSVG is in another driving state or in an ON state, the p-polarized light P is coupled out of the light guide LG. However, the s-polarized light S is reflected at the boundary surface of the light guide LG and propagates farther in the light guide LG. The volume grating itself can be switchable or controllable here, where the switchable polarization-selective volume grating PSVG is divided into two sections for better comprehension in FIG. 25, to be able to better illustrate the ability to control the switchable polarization-selective volume grating PSVG in conjunction with the light path. In a similar manner, only with circular light instead of linearly polarized light, such a light guiding device can also be implemented using a switchable Bragg polarization grating.

A light guiding device is schematically illustrated in FIG. 26, the light decoupling device of which comprises a Bragg polarization grating B-PG, which deflects light of all wavelengths, but at different angles, and multiple volume gratings VG. The multiple volume gratings VG form a volume grating stack, which in this exemplary embodiment has four volume gratings VG1, VG2, VG3, and VG4. Light of the red wavelength R, light of the green wavelength G, and light of the blue wavelength B is now incident at the same angle on the Bragg polarization grating B-PG. The light of the green wavelength G is deflected in this case so that it exits from the Bragg polarization grating B-PG perpendicularly to the surface or boundary surface of the light guide LG. Light of the red wavelength R and light of the blue wavelength B, however, exit at a different angle from the Bragg polarization grating B-PG, as can be seen on the basis of the dashed and the solid arrows in FIG. 26.

The Bragg polarization grating B-PG is followed by the volume grating stack having the four volume gratings VG1, VG2, VG3, and VG4. These volume gratings VG1, VG2, VG3, and VG4 of the volume grating stack are designed as wavelength-selective. In this exemplary embodiment, this means that the light of the green wavelength G passes undeflected through all four volume gratings VG1, VG2, VG3, and VG4 and is then coupled out of the light guide LG. The light of the red wavelength R passes through the first two volume gratings VG1 and VG2 undeflected and is only deflected by the last two volume gratings VG3 and VG4 so that it exits from the light guide LG at the same angle as the light of the green wavelength G. The light of the blue wavelength B is only deflected by the first two volume gratings VG1 and VG2 and passes undeflected through the last two volume gratings VG3 and VG4, where the volume gratings VG1 and VG2 deflect the light of the blue wavelength in such a way that it exits at the same angle from the light guide LG as the light of the green wavelength G or red wavelength. One pair of volume gratings is used in each case for correcting the exit angle of the light for the blue wavelength and the light for the red wavelengths from the light guide, because a good wavelength selectivity may be set more easily for greater angle of deflections of the volume gratings. For example, the light of the blue wavelength B is firstly again deflected to a greater angle by the volume grating VG1 before the volume grating VG2 deflects the light of the blue wavelength so that it exits perpendicularly to the surface or boundary surface of the light guide LG therefrom.

The explanations now following relate to the separate influencing of the imaging beam path and the illumination beam path in a display device having diffractive elements, either in a Fourier plane of the SLM or a light source plane of the illumination device or an image plane of the SLM.

In a holographic display device or another preferably three-dimensional display device, for example, a stereoscopic display device, at least one diffractive optical element is used in such a way that it essentially influences only the illumination beam path or only the imaging beam path. This at least one diffractive optical element was also referred to in the above description of the invention as a variable imaging system. Since it is now primarily supposed to relate in general to the influencing of an illumination beam path and an imaging beam path, the designation “diffractive optical element” is used hereafter.

The influencing of only the illumination beam path or only the imaging beam path is achieved in that at least one diffractive optical element is arranged either in or close to an image plane of the SLM, to influence only the illumination beam path. Instead, the at least one diffractive optical element can be arranged in or close to a Fourier plane of the SLM to influence only the imaging beam path. In FIGS. 12 and 13, for example, at least one diffractive element, identified therein as a variable imaging system 30, is arranged in a light source plane of the illumination device, so that it influences only the imaging beam path. Alternatively or additionally, for example, the first imaging element 27 also shown in FIGS. 12 and 13, which is arranged in the plane of the SLM, can have at least one diffractive element which then only influences the illumination beam path.

In a three-dimensional display device in which a light source image of at least one light source of an illumination device is present in an observer plane, a diffractive optical element in or close to a Fourier plane of the SLM would influence the imaging beam path and thus influences the image plane of the SLM without changing the position and dimensions of the observer region, in particular a virtual observer window. A diffractive optical element in or close to an image plane of the SLM would influence the position and dimensions of the observer region without having an effect on the image distance of the SLM, however. In a three-dimensional display device, in which an image of the SLM is generated in the observer plane, vice versa, a diffractive optical element in or close to an image plane of the SLM influences the position of a reference plane for the hologram calculation, which can be selected, for example, as a virtual image plane in the meaning of WO 2016/156287 A1, without changing the position and dimensions of the observer region. The content of WO 2016/156287 A1 is to be incorporated here in its entirety. A diffractive optical element in or close to a Fourier plane of the SLM influences the location and dimensions of the observer region without influencing the distance of the reference plane.

Specific configurations are described in greater detail hereafter:

In particular, in one configuration for a display device which generates a light source image in the observer plane, a two-step system is used which generates an intermediate image of the observer region or an intermediate image of the light source in a Fourier plane of the SLM and in which at least one diffractive optical element is arranged in or very close to this intermediate image plane to only influence the imaging beam path and leave the position of the observer region unchanged. Such an arrangement having a light guide is shown in FIG. 12. In this case, the at least one diffractive element or variable imaging system 30 is arranged in the intermediate image plane of the illumination device. In general, such an arrangement having at least one diffractive element can also be used in devices without light guide.

In particular, in a display device which generates a light source image in the observer plane, the at least one diffractive optical element in a Fourier plane of the SLM can have a lens function which influences the position of the image plane of the SLM.

In a display device which generates a light source image in the observer plane, the position of the image plane of the SLM can preferably be adapted by the at least one diffractive optical element in a Fourier plane of the SLM so that the average size of subholograms for the calculation of a preferably three-dimensional scene is reduced in comparison to a display device without use of a diffractive optical element.

The at least one diffractive optical element in a Fourier plane of the SLM can be designed in such a way that it corrects aberrations in the imaging beam path. The at least one diffractive optical element can be designed as controllable. Furthermore, the diffractive optical element can be designed as a liquid crystal grating (LCG). Furthermore, two diffractive optical elements can also be used, where a horizontal cylinder lens function is written into one diffractive optical element and a vertical cylinder lens function is written into the other diffractive optical element

In a display device, which generates a light source image in the observer plane and which generates a segmented multiple image of the SLM to generate a large field of view, at least one controllable diffractive optical element is arranged in a Fourier plane of the SLM so that a lens function is written into the at least one diffractive optical element for each segment of a multiple image so that the image plane of the SLM is generated at a similar or equal distance from the observer for all segments.

In a display device which generates a light source image in the observer plane and which generates a segmented multiple image of the SLM to generate a large field of view, and which comprises a light guide having different numbers of reflections in the light guide to generate the individual segments of a multiple image of the SLM, the at least one controllable diffractive optical element can be arranged in a Fourier plane of the SLM to equalize the different optical paths of the light in the light guide for various segments and to generate an image plane of the SLM for all segments at a similar or equal distance from the observer.

In a display device which generates a light source image in the observer plane and which generates a segmented multiple image of the SLM to generate a large field of view, and which comprises a light guide having different numbers of reflections in the light guide to generate the individual segments of a multiple image of the SLM and at least one grating element for coupling and/or decoupling light into or out of, respectively, the light guide, the at least one controllable diffractive optical element can be arranged in a Fourier plane of the SLM to correct the aberrations in the imaging beam path generated by the at least one grating element.

In a display device which generates a light source image in the observer plane and which generates a segmented multiple image of the SLM to generate a large field of view, and which comprises a light guide having different numbers of reflections in the light guide to generate the individual segments of a multiple image of the SLM and at least one grating element for coupling and/or decoupling light into or out of, respectively, the light guide, the at least one controllable diffractive optical element can be arranged in an image plane of the SLM to correct the aberrations in the illumination beam path generated by the at least one grating element.

In a display device which generates a light source image in the observer plane and which generates a segmented multiple image of the SLM to generate a large field of view, and which comprises a light guide having different numbers of reflections in the light guide to generate the individual segments of a multiple image of the SLM, the at least one controllable diffractive optical element can be arranged in an image plane of the SLM to equalize the different optical paths of the light in the light guide for the various segments of the multiple image of the SLM and to generate an observer region at an identical position for all segments. The following is also to be described for this configuration of a display device:

If a curved light guide forms the section of a circular arc having the center of the observer region as the center point of the circle and if decoupling of the light out of the light guide after different numbers of reflections in the light guide follows for such a light guide, due to the use of a diffractive optical element in an image plane of the SLM, the observer region thus advantageously already results for all segments of a multiple image of the SLM at the same position, so that an additional correction in this regard is not necessary. However, this does restrict the usable light guide geometries.

The described embodiment having at least one diffractive optical element in an image plane of the SLM thus enables other light guides to also be used, for example, flat or plane light guides or curved light guides, the curvature of which deviates from the section of a circular arc, and nonetheless an observer region can be generated for multiple segments at the same position.

In a display device which generates a light source image in the observer plane, the distance at which the eyes of an observer focus can be detected in a holographic or stereoscopic system by means of gaze tracking. The position of the image plane of the SLM can be changed using the at least one controllable diffractive optical element in the Fourier plane of the SLM so that the image plane of the SLM is located at a similar or equal distance from the observer as the distance detected by means of gaze tracking.

However, the invention is not to be restricted to the embodiments illustrated and described here. For example, the exemplary embodiments or embodiments mentioned here are also transferable accordingly to a display device which generates an image of the SLM in the observer plane.

The following embodiment will be briefly described as an example: In a display device, which generates an image of the SLM in the observer plane and which generates a segmented multiple image of an diffraction order in a Fourier plane of the SLM to generate a large field of view, at least one controllable diffractive optical element can be arranged in an image plane of the SLM so that a lens function is written into the at least one diffractive optical element for each segment in such a way that the Fourier plane of the SLM is generated as a reference plane for the hologram calculation for all segments at a similar or equal distance from the observer.

Polarization-selective Bragg grating elements or Bragg polarization gratings are also to be discussed in general hereafter, which can advantageously be used in a light decoupling device of a light guiding device to couple light out of a light guide. This light guiding device can then advantageously be used in a head-mounted display.

The Bragg polarization grating can be produced by means of a bulk photoalignment method, which ensures an independence of the molecular orientation of each pattern surface of an alignment layer and enables the formation of inclined interference patterns. For this purpose, only the rotation of the pattern by a suitable angle φ is necessary. It is assumed in this case that such an inclined holographic polarization exposure can effect a complex 3D alignment of the LC polymer without use of additional chemical additives (chiral LC additives) or alignment layers. It is advantageous that the LC director is located perpendicularly to the interference pattern in the plane. This means that the efficient local birefringence is not dependent on the inclination of the interference pattern. This is an advantage of photo-cross-linked LC polymers.

It was possible to establish by simulations that when a right-circular polarized light beam is incident on the Bragg polarization grating, the diffraction occurs in the −1 diffraction order, where the Bragg polarization grating converts the incident right-circular polarized light into left-circular polarized light. A diffraction efficiency of approximately 98% results in this case in this −1 diffraction order. The other diffraction orders, the zeroth diffraction order and the +1 diffraction order, have a negligible diffraction intensity. In contrast, if left-circular polarized light is used which is incident on the Bragg polarization grating, diffraction hardly occurs in the −1 diffraction order and +1 diffraction order, but rather the majority of the light is in the zeroth diffraction order, where a diffraction efficiency of approximately 93% is present. The left-circular polarized light passes without deflection and conversion into another polarization state through the Bragg polarization grating.

The Bragg polarization grating has a wide spectral acceptance and a wide angle acceptance because of its low thickness. The spectral acceptance and the angle acceptance of a Bragg polarization grating which is optimized, for example, for a normal light incidence having a wavelength of λ=532 nm was measured using right-circular polarized laser beams having wavelengths of 488 nm, 532 nm, and 633 nm and corresponding results were achieved. In this case, the Bragg polarization grating which has a diffraction efficiency of (η_{±1}) approximately >90% in the first diffraction order with a green wavelength had almost the same diffraction efficiency with a red and blue wavelength. This in turn has the advantage that this grating element can be used for the entire visible spectral range.

The angle acceptance of the Bragg polarization grating is approximately 35°.

Such Bragg polarization gratings can be used in a broad field of application because of the unique properties thereof, such as high optical quality of thin films, a high diffraction efficiency, and a broad or wide angle acceptance and large spectral acceptance. For example, they can advantageously be used in head-mounted displays (HMD) or also in devices for AR (augmented reality) applications or VR (virtual reality) applications. These grating elements enable a very efficient beam deflection of coherent light in combination with a polarization switch. The angle of deflection, i.e., the angle between two “operative” diffraction orders, i.e., the zeroth and the first diffraction order, of the Bragg polarization grating were achieved in simulations at 42° in air with a wavelength used of 532 nm. The switching contrast, i.e., the ratio of the diffraction efficiency with opposing circular polarizations, can be approximately 100. The specific polarization and diffraction properties of the Bragg polarization grating offer the option of combining multiple such grating elements in one stack. For example, a grating element stack can comprise two such grating elements, which are designed for normal light incidence of green light. In operation, such a grating element stack would deflect an incident light beam either in the +1 diffraction order or in the −1 diffraction order, depending on the polarization state of the light, right-circular polarized light or left-circular polarized light. The two grating elements of the grating element stack have the same period of Λ=0.77 μm and the same angle of inclination, but an opposing inclination of the interference pattern. The rotation angle φ can be kept either at +28° or at −28° by holographic exposure. After the holographic exposure and the tempering, the grating elements are fixed with one another using UV-curing glue.

The right-circular polarized light beam incident on the grating element stack is diffracted by the first grating element in its −1 diffraction order and passes through the second grating element without diffraction because of its large angle deviation from the Bragg angle of the second grating element. A left-circular polarized light beam incident on the grating element stack is not diffracted by the first grating element, but rather is diffracted by the second grating element in its +1 diffraction order. The diffraction efficiency of the grating element stack in the ±1 diffraction order is approximately 85%. Such a grating element stack can provide an angle of diffraction of ±42° at a wavelength of 532 nm, which results in a total angle of deflection of 84° in air. Such an effective, large, and symmetrical one-step polarization-dependent light deflection cannot be achieved using a single Bragg polarization grating.

In particular in the light guiding device or display device according to the invention, such a grating element stack or also only a single Bragg polarization grating can advantageously be used.

Moreover, combinations of the embodiments and/or exemplary embodiments are possible. Finally, it is also to be very particularly noted that the above-described exemplary embodiments are used solely to describe the claimed teaching, but does not restrict this teaching to the exemplary embodiments.

1. A light guiding device for guiding light, comprising a light guide, a light coupling device, and a light decoupling device, where the light propagates within the light guide via a reflection at boundary surfaces of the light guide, and where the decoupling of the light out of the light guide by the light decoupling device is provided after a predetermined number of reflections of the light at boundary surfaces of the light guide.

2. The light guiding device as claimed in claim 1, wherein, if the light incident on the light guiding device is formed as a light bundle or light field having multiple or a plurality of light beams, a decoupling out of the light guide is provided for the light beams after an equal number of reflections at the boundary surfaces of the light guide in each case for all light beams of the light bundle or light field.

3. The light guiding device as claimed in claim 1, wherein a light incidence position on one of the boundary surfaces of the light guide which the light reaches after a predetermined number of reflections is determinable from geometric properties and optical properties of the light guide and optical properties of the light coupling device.

4. The light guiding device as claimed in claim 3, wherein a thickness and/or a possible curvature of the boundary surfaces of the light guide are usable as geometric properties of the light guide to determine the light incidence position, where an index of refraction of the light guide material is usable as an optical property of the light guide.

5. The light guiding device as claimed in claim 1, wherein the light decoupling device is arranged on the light guide in such a way that the position of the light decoupling device corresponds to the light incidence position, which the light reaches on one of the boundary surfaces of the light guide after a predetermined number of reflections.

6. The light guiding device as claimed in claim 1, wherein the light decoupling device is designed to be controllable, where the light decoupling device is controllable in such a way that in a driving state of the light decoupling device, light is coupled out after a predetermined number of reflections and in another driving state of the light decoupling device, the light propagates further in the light guide.

7. The light guiding device as claimed in claim 1, wherein the light decoupling device is divided into sections, where the light decoupling device is sectionally designed to be controllable, where the light decoupling device is controllable in such a way that the number of reflections of the light at the boundary surfaces of the light guide is changeable by a driving state of a section of the light decoupling device, which corresponds to the light incidence position which the light reaches after a number of reflections, and by another driving state of a further section of the light decoupling device, which corresponds to the light incidence position which the light reaches after a further number of reflections.

8. The light guiding device as claimed in claim 1, wherein the light coupling device comprises at least one grating element, preferably a volume grating, or at least one minor element.

9. The light guiding device as claimed in claim 8, wherein a grating constant of the grating element or an angle of inclination of the mirror element in relation to the surface of the light guide is usable as an optical property of the light coupling device for the determination of the light incidence position, which the light reaches after a predetermined number of reflections.

10. The light guiding device as claimed in claim 1, wherein the light decoupling device comprises at least one grating element, in particular a deflection grating element, preferably a volume grating, or at least one minor element.

11. The light guiding device as claimed in claim 10, wherein the light decoupling device comprises at least one controllable grating element.

12. The light guiding device as claimed in claim 10, wherein the light decoupling device comprises at least one passive grating element in conjunction with a switch element, preferably a polarization-selective grating element in conjunction with a polarization switch.

13. The light guiding device as claimed in claim 11, wherein the at least one controllable grating element of the light decoupling device extends over a predefined area of the light guide, where the grating element is divided into switchable sections.

14. The light guiding device as claimed in claim 1, wherein the light guide is formed at least in sections as curved at least in one direction.

15. The light guiding device as claimed in claim 14, wherein the light guide has the shape of a hollow cylinder at least in sections, where its boundary surfaces are formed as sections of the hollow cylinder having differing radius.

16. The light guiding device as claimed in claim 1, wherein the light deflection angle of the light coupling device and the light deflection angle of the light decoupling device are selected opposing in such a way that a light beam incident perpendicularly on the surface of the light guide also exits perpendicularly from the light guide.

17. The light guiding device as claimed in claim 1, wherein the dimensions of the light coupling device are greater than the dimensions of a light bundle incident on the light guiding device, where the coupling position of a light bundle into the light guide is displaceable within the boundaries of the dimensions of the light coupling device.

18. A display device, in particular a near-to-eye display device, comprising an illumination device having at least one light source, at least one spatial light modulation device, an optical system, and a light guiding device as claimed in claim 1.

19. The display device as claimed in claim 18, wherein an image of the spatial light modulation device is generatable by the light guiding device and the optical system.

20. The display device as claimed in claim 18, wherein a light source image of the at least one light source of the illumination device or an image of the spatial light modulation device is generatable by the light guiding device and the optical system in the light path after decoupling of the light out of the light guiding device.

21. The display device as claimed in claim 20, wherein a virtual observer region is generatable in a plane of the light source image or in a plane of an image of the spatial light modulation device.

22. The display device as claimed in claim 18, wherein the light guide of the light guiding device is curved at least in sections as a section of a hollow cylinder, where a virtual observer region is generatable in a region of a center point of a circular arc of the hollow cylinder.

23. The display device as claimed in claim 19, wherein the imaging defines a field of view, within which information of a scene encoded in the spatial light modulation device is reconstructed for observation through a virtual observer region.

24. The display device as claimed in claim 18, wherein a multiple image of the spatial light modulation device composed of segments is generated by the light guiding device and the optical system, where the multiple image defines a field of view within which information of a scene encoded in the spatial light modulation device is reconstructed for observation through a virtual observer region in the plane of a light source image.

25. The display device as claimed in claim 18, wherein a multiple image of a diffraction order composed of segments is generated in a Fourier plane of the spatial light modulation device by the light guiding device and the optical system, where the multiple image defines a field of view, within which information of a scene encoded in the spatial light modulation device is reconstructed for observation through a virtual observer region in an image plane of the spatial light modulation device.

26. The display device as claimed in claim 19, wherein for the image or for a single segment of the multiple image, the decoupling of light coming from various pixels of the spatial light modulation device after entry into the light guiding device is provided after a number of reflections at boundary surfaces of the light guide equal in each case for all pixels.

27. The display device as claimed in claim 24, wherein for different segments of the multiple image, the number of the reflections of the light at the boundary surfaces of the light guide for the generation of one segment differs from the number of the reflections of the light at the boundary surfaces of the light guide for the generation of another segment.

28. The display device as claimed in claim 24, wherein for different segments of a multiple image, the number of the reflections of the light at the boundary surfaces of the light guide is equal, and the coupling position of the light into the light guide differs for these segments.

29. The display device as claimed in claim 28, wherein a light deflection device is provided in front of the light guiding device in the light direction for displacing the coupling position of the light into the light guide.

30. The display device as claimed in claim 18, wherein the optical system is designed as a two-step optical system, where in a first step an intermediate image of the at least one light source of the illumination device is generated by at least one first imaging element of the optical system, where in a second step the intermediate image of the light source is imaged in a virtual observer region in the light path after the decoupling of the light out of the light guide by at least one second imaging element of the optical system.

31. The display device as claimed in claim 18, wherein at least one variable imaging system is provided, which is arranged in front of the light guiding device in the light direction.

32. The display device as claimed in claim 31, wherein the at least one variable imaging system is provided close to or in an intermediate image plane of the at least one light source of the illumination device, and/or a variable imaging system is provided close to the spatial light modulation device or in an image plane of the spatial light modulation device.

33. The display device as claimed in claim 31, wherein the at least one variable imaging system comprises at least one imaging element, which is designed as a grating element having controllable variable period or as controllable liquid crystal element or as at least two lens elements, the distances of which are variable.

34. The display device as claimed in claim 33, wherein a changeable prism function or a changeable lens function and/or a changeable complex phase function is written into at least one controllable imaging element of the at least one variable imaging system.

35. The display device as claimed in claim 31, wherein the at least one variable imaging system is arranged in a plane of the light source image of the at least one light source of the illumination device for correction of aberrations in an imaging beam path.

36. The display device as claimed in claim 31, wherein the at least one variable imaging system is arranged in an image plane of the spatial light modulation device for correction of aberrations in an illumination beam path.

37. The display device as claimed in claim 31, wherein the at least one variable imaging system is provided to generate a virtual observer region for all segments of the multiple image at an identical position.

38. The display device as claimed in claim 18, wherein the at least one controllable grating element of the light decoupling device of the light guiding device comprises at least one lens function.

39. A head-mounted display having two display devices, the display devices are each designed according to a display device as claimed in claim 18 and are respectively assigned to a left eye of an observer and a right eye of the observer.

40. A method for generating a reconstructed scene by a spatial light modulation device and a light guide, comprising
the spatial light modulation device modulates incident light with required information of the scene,
the light modulated by the spatial light modulation device is coupled into the light guide by a light coupling device and is decoupled out of the light guide by a light decoupling device, and
the light is decoupled out of the light guide after a predetermined number of reflections at boundary surfaces of the light guide.

41. The method as claimed in claim 40, wherein an image of the spatial light modulation device or a multiple image of the spatial light modulation device composed of segments is generated.

42. The method as claimed in claim 41, wherein an intermediate image of the spatial modulation device is generated at least for a part of the segments of the multiple image within the light guide.

43. The method as claimed in claim 41, wherein an image of the spatial light modulation device is displaced for each individual segment of the multiple image by at least one variable imaging system, preferably arranged in a plane of a light source image of at least one light source of an illumination device in the light path in front of the coupling of the light into the light guide, in such a way that a differing optical light path in the light guide resulting for the individual segments is at least partially compensated for.

44. The method as claimed in claim 43, wherein an aberration correction is carried out for each individual segment of the multiple image by the at least one variable imaging system in such a way that at least one optical property of the variable imaging system is changed, where a correction function is calculated and stored once in each case for each segment.

45. The method as claimed in claim 44, wherein the aberration correction is carried out in the intermediate image plane of the illumination device and/or in the amplitude and phase curve of a hologram encoded in the spatial light modulation device.

46. The method as claimed in claim 44, wherein the calculation of the correction function is carried out by a computational inversion of the light path and backtracing of light beams from a virtual observer region through the light guide into a plane of the light source image of the at least one light source of the illumination device.

47. The display device as claimed in claim 25, wherein for different segments of the multiple image, the number of the reflections of the light at the boundary surfaces of the light guide for the generation of one segment differs from the number of the reflections of the light at the boundary surfaces of the light guide for the generation of another segment.

48. The display device as claimed in claim 25, wherein for different segments of a multiple image, the number of the reflections of the light at the boundary surfaces of the light guide is equal, and the coupling position of the light into the light guide differs for these segments.
